(19) United States
(12) Patent Application Publication
(10) Pub. No.: US 2017/0013855 A1
(43) Pub. Date: Jan. 19, 2017

(54) FOOD USING SOYBEAN POWDER AND METHOD FOR MANUFACTURING THEREOF

(71) Applicant: The Nisshin OilliO Group, Ltd., Tokyo (JP)

(72) Inventors: Masaki TAGI, Yokosuka-shi (JP); Takahiro YAMAGUCHI, Yokosuka-shi (JP); Daisuke SUYAMA, Yokosuka-shi (JP); Ryoichi MINOSHIMA, Yokosuka-shi (JP); Kazumitsu HONDA, Yokosuka-shi (JP)

(73) Assignee: The Nisshin OilliO Group, Ltd., Tokyo (JP)

(21) Appl. No.: 15/121,126

(22) PCT Filed: Nov. 17, 2014
(86) PCT No.: PCT/JP2014/080378

§ 371 Date: Aug. 24, 2016

(30) Foreign Application Priority Data
Feb. 27, 2014 (JP) 2014-036100
Feb. 27, 2014 (JP) 2014-036171
Feb. 27, 2014 (JP) 2014-036288
Feb. 27, 2014 (JP) 2014-037128
Feb. 27, 2014 (JP) 2014-037602

(51) Int. Cl. A23D 7/005; A23L 2/66; A23L 11/00; A23C 20/02; A23G 9/32; A23G 9/42; A23G 3/40; A23G 3/48; A23G 9/52; A23L 23/00

(52) U.S. Cl. CPC A23D 7/0053; A23G 9/52; A23L 2/66; A23L 11/03; A23L 23/00; A23G 9/327; A23G 9/42; A23G 3/40; A23G 3/48; A23C 20/025; A23V 2002/00

(57) ABSTRACT

The present invention relates to a food comprising soybean powder and an edible fat or oil. More specifically, the present invention relates to a food in which the edible fat or oil contains a triglyceride with a medium-chain fatty acid(s) at a ratio of 50% by mass or higher relative to the mass of the edible fat or oil. In particular, the present invention relates to a food which is reduced in beany flavor, grassy flavor, astringency, oily feeling (oiliness), oily odor, and the like, which has a good flavor, and which is improved in feel-on-the-tongue, mouthfeel, milkiness, melt-in-the-mouth, smoothness, and richness, and to a method for producing the food. Moreover, the present invention relates to a method for improving a flavor originated from soybean powder in a food comprising the soybean powder and an edible fat or oil.

### TECHNICAL FIELD

The present invention relates to a food comprising soybean powder (flour) and an edible fat or oil. More specifically, the present invention relates to the food, in which the edible fat or oil contains a triglyceride with a medium-chain fatty acid(s) at a ratio of 50% by mass or higher relative to the mass of the edible fat or oil. Especially, the present invention relates to a food which is reduced in beany flavor, grassy flavor, astringency, oily feeling (oiliness), oily odor, and the like, which has a good flavor, and which is improved in feel-on-the-tongue, mouthfeel, milkiness, melt-in-the-mouth, smoothness, and richness and to a method for producing the food. Moreover, the present invention relates to a method for improving a flavor originated from soybean powder in a food comprising the soybean powder and an edible fat or oil.

### BACKGROUND ART

To protect citizens' good health, the labeling of seven types of ingredients (egg, milk, wheat, buckwheat, peanut, shrimp/prawn/lobster, and crab) among foods which are especially likely to cause allergies is obliged under Food Sanitation Act because of the high incidence or severity of the allergies. However, when foods are prepared considering the allergies caused by the seven types of ingredients (hereinafter, also referred to as “specified ingredients”), the convenience of the food preparation is impaired, and also the degree of freedom in planning the menu is greatly limited. For these reasons, inventions of food preparation or production and development of foods by using ingredients alternative to the specified ingredients have been awaited.

As an ingredient alternative to the above-described specified ingredients, soybeans can be regarded as an important alternative ingredient. Soybeans are not only a high-quality protein source with a high amino acid score, but also rich in polyunsaturated fatty acids, dietary fibers, and various vitamins and minerals, and further soybeans contain a wide variety of components having health functions such as isoflavones, lecithins, and saponins. In addition, soybeans do not contain cholesterol, and have been widely used as a food alternative to meat. Further, soybeans are expected to be used as an alternative to “egg” or “milk.”

Particularly, cold sweets, especially, ice creams, which are foods mainly containing a dairy ingredient such as cream and using egg in some cases, are a type of foods in which substitution with soybeans is expected. Actually, a cold sweet using soybean powder was proposed even before the allergy labeling attracted great attention (for example, Patent Literature 1).

Meanwhile, regarding cheese, nutrient-enriched cheese has been developed in which soy proteins or soy milk is added to cheese ingredients to increase the nutritive value of cheese (Patent Literatures 2 and 3). It is advantageous that nutrient components originated from soybeans and not contained in cheese can also be ingested by ingesting the cheese in which soy proteins or soy milk is added to cheese ingredients. However, since cheese is used as an ingredient, the nutrient-enriched cheese inevitably contains an allergenic material originated from milk, which is one of the specified ingredients. Hence, the nutrient-enriched cheese can be used as a common food, but cannot be used as a food prepared by considering allergies caused by the specified ingredients. Cheese-like foods not using milk as an ingredient have been also developed (Patent Literatures 4 to 7). However, the cheese-like food of Patent Literature 4 has to use wheat proteins as an ingredient, and hence inevitably contains an allergenic material originated from wheat, which is one of the specified ingredients. Meanwhile, for production of the cheese-like foods of Patent Literatures 5 to 7, it is necessary to perform a lactic acid fermentation step, which requires lactic acid bacteria and a fermentation technology, and which leads to increase in production time. Hence, the cheese-like foods of Patent Literatures 5 to 7 have such a problem that the production cost is not necessarily satisfactory.

In addition, regarding ice creams, soy milk, reduced-fat soy milk powder, and soy protein isolate have been used as alternatives to egg or milk (Patent Literatures 8 to 10). These ingredients are obtained by removing nutrient components mainly including dietary fibers from soybeans, and cannot be said to sufficiently make use of the nutrient functions of soybeans themselves. In addition, these ice creams are poorer in richness than cold sweets using milk and/or egg as the ingredients.

Meanwhile, regarding a soft candy, a soft candy is produced by mixing a saccharide, a fat or oil, condensed milk, and the like together, and boiling down the mixture until a predetermined water content is achieved, followed by cooling and shaping. For producing a soft candy, there has been a demand for a softer and smoother mouthfeel. In this respect, many techniques for mainly increasing the fat or oil content ratio have been disclosed from the past. The fat or oil not only contributes to the soft mouthfeel of the soft candy, but also is effective for preventing the soft candy from sticking to the teeth during chewing. However, if the amount of the fat or oil added is excessively large, the soft candy tends to have oily feeling, oily odor, or poor mouthfeel. On the other hand, if the amount of the fat or oil added is small, it is difficult to provide the softness, which is characteristic of soft candy, and the soft candy tends to easily stick to the teeth and the package paper. In this respect, to solve the problems caused by the addition of a fat or oil to a soft candy, a technique in which the fat or oil and milk proteins added to a soft candy are emulsified by using a polyglycerin fatty acid ester, which is an emulsifier, and a technique in which the stickiness is reduced by stabilizing emulsification by using a combination of a sucrose fatty acid ester having an HLB value of 3 to 7 with multiple emulsifiers (Patent Literatures 11 and 12). In addition, to solve the problem of the flavor attributable to a strange taste and odor of an emulsifier used in a soft candy, a technique has been known by which a soft candy is improved in terms of the oil retainability, the smoothness, and the stickiness by using components originated from proteins, especially, soy protein hydrolysate polypeptides having molecular weights in the range of 5,000 to 35,000 (Patent Literature 13). However, from the viewpoint of the flavor, this technique still has such problems that the polypeptides impart a characteristic bitterness, and that original nutrient components of soybeans are fewer than those in unprocessed soybeans.

Moreover, consumers have recently become very highly conscious of healthy diets. For this reason, natural foods and functional foods have attained popularity. Especially, soy milk, which is prepared by using soybeans as an ingredient, contains high-quality proteins and plant-derived linoleic acid, and is rich in nutrient components such as vitamin E and lecithins. Hence, the consumption of soy milk, which is a functional food considered as a gift from nature, has increased year after year. In addition, isoflavones, which are a class of the components of soybean, have attracted attention as having various physiological functions such as prevention of osteoporosis, alleviation of postmenopausal syndrome, and prevention of arteriosclerosis.

Under such circumstances, soy milk and methods for producing soy milk have been studied intensively from the past. However, it cannot be said that soy milk is a beverage suitable for all people, because of the beany flavor, grassy flavor, astringency, and the like which are characteristic of soybeans and which are formed in grinding and extracting steps of soybeans.

In addition, as described above, soybeans are rich in nutrient components, but have an unpreferable flavor including grassy flavor, astringency, and the like. In conventional methods for reducing the unpreferable flavor of soybeans, soybeans in which an enzyme is inactivated or deficient have been used, defatted soybeans obtained by defatting have been used, or protein isolate has been used.

However, the mere use of the soybeans in which an enzyme is inactivated or deficient does not satisfactorily reduce the unpreferable flavor of soybean including the grassy flavor, the astringency, and the like. For example, techniques are known in which a soybean beverage is prepared by using powder of soybeans in which the remaining lipoxygenase is inactivated or made deficient by employing a milder heat treatment during the preparation of the soybean powder or other means (Patent Literatures 14 to 16). However, the grassy flavor, the astringency, and the like of soybeans are not reduced sufficiently.

In addition, another problem regarding nutrient components is that roughly purified soy proteins and polypeptides obtained by further degrading the roughly purified soy proteins are poorer in the original nutrient components of soybeans than powder of soybeans not subjected to purification and the like. This is because, in addition to the characteristics of being a high-quality protein source with a high amino acid score, soybeans contain excellent nutrient components, i.e., soybeans contain large amounts of polyunsaturated fatty acids, do not contain cholesterol, are rich in dietary fibers and various vitamins and minerals, and further contain a wide variety of components with health functions such as isoflavones, lecithins, and saponins.

On the other hand, to obtain larger amounts of nutrients from soybeans, it is preferable not to use the above-described defatted soybeans, soy protein isolate, or the like, but to use soybeans themselves (for example, soybean powder), so that the escape of components can be prevented as much as possible. However, when soybeans themselves are used, an unpreferable flavor of soybeans is also left more intense. In addition, considering the convenience and economical efficiency for a food ingredient, the conventionally employed simple use of an ingredient with a reduced unpleasant taste and a reduced unpleasant odor of soybeans is insufficient. This is because the production is complicated and the economical efficiency is low, and also because the unpleasant taste and the unpleasant odor of soybeans are somewhat left. In this respect, masking technologies have been developed so far by which the unpleasant taste and the unpleasant odor of soybeans are sealed.

For example, a technique has been known which relates to a milk-flavored soy protein composition obtained by using dextrins (a masking agent) and a milk-flavored fat or oil triglyceride with soy proteins in a calcium form (Patent Literature 17). In addition, a technique has been also known in which a specific diglyceride whose constituent fatty acids comprise saturated or unsaturated fatty acids having 14 to 24 carbon atoms is used for a soy food to remove the grassy flavor and astringency originated from soybeans (Patent Literature 18).

However, Patent Literatures 17 and 18 are directed to the techniques in which the unpreferable soybean flavor of the soy proteins or the soy food is masked with dextrins and a milk-flavored fat or oil or with a specific diglyceride. Hence, neither Patent Literature 17 nor Patent Literature 18 shows that an ordinary triglyceride fat or oil has an effect of masking the unpleasant taste and the unpleasant odor of soybeans.

Moreover, a technique is known by which the odors of ingredients such as the grassy flavor and roasted soybean powder flavor of soy proteins are eliminated by adding polysaccharides, amino acids, or polymeric compounds such as milk proteins in the form of an O/W emulsion (Patent Literature 19). However, in this technique, the fat or oil triglyceride itself is not used as a masking agent, but is used as a tasty fat or oil for emulsification of the O/W emulsion.

In sum, beverages rich in nutrient components of soybeans and also excellent in flavor have not been obtained by simply using an ingredient having a reduced unpleasant taste and a reduced unpleasant odor of soybeans so far. Therefore, there has been a demand for development of a technique related to a food which does not use anyone of flavor-impairing ingredients such as emulsifiers, protein isolates, hydrolyzed proteins, and polypeptides, which is excellent in nutrients, which is reduced in beany flavor, grassy flavor, astringency, oily feeling (oiliness), oily odor, and the like, which has a good flavor, and which is improved in feel-on-the-tongue, mouthfeel, milkiness, melt-in-the-mouth, smoothness, and richness.

### CITATION LIST

### Patent Literatures

Patent Literature 1: Japanese Patent Application Publication No. Sho 62-294041
Patent Literature 2: Japanese Patent Application Publication No. 2004-129648
Patent Literature 3: Japanese Patent Application Publication No. 2001-275600
Patent Literature 4: Japanese Patent Application Publication No. 2011-73
Patent Literature 5: Japanese Patent Application Publication No. Hei 3-112445
Patent Literature 6: Japanese Patent Application Publication No. Hei 7-236417
Patent Literature 7: International Publication No. WO 2009/001443
Patent Literature 8: Japanese Patent Application Publication No. 2004-73154
Patent Literature 9: Japanese Patent Application Publication No. 2013-13395
Patent Literature 10: Japanese Patent Application Publication No. Hei 11-103783
Patent Literature 11: Japanese Patent Application Publication No. Hei 5-7459
Patent Literature 12: Japanese Patent No. 3108185
Patent Literature 13: Japanese Patent No. 3632659
Patent Literature 14: Japanese Patent Application Publication No. 2004-141155
Patent Literature 15: Japanese Patent Application Publication No. Sho 62-244348
Patent Literature 16: Japanese Patent Application Publication No. 2006-129877
Patent Literature 17: Japanese Patent No. 3055376
Patent Literature 18: Japanese Patent No. 2938701
Patent Literature 19: Japanese Patent Application Publication No. Hei 5-41951

### SUMMARY OF INVENTION

An object of the present invention is to provide a food which uses soybean powder, but which is free from the unpleasant taste and the unpleasant odor of soybeans, and, especially, which is reduced in beany flavor, grassy flavor, astringency, oily feeling (oiliness), oily odor, and the like, and a method for producing the food.

Another object of the present invention is to provide a food which uses soybean powder and which is excellent in flavor and nutrients, and a method for producing the food.

Another object of the present invention is to provide a method for improving a flavor originated from soybean powder in a food comprising the soybean powder and an edible fat or oil.

Still another object of the present invention is to provide a food which is improved in feel-on-the-tongue, mouthfeel, milkiness, melt-in-the-mouth, smoothness, and richness, and a method for producing the food.

Yet another object of the present invention is to provide a food which does not use, as an ingredient, any one of the specified ingredients, which are allergenic materials originated from egg, milk, wheat, buckwheat, peanut, shrimp/prawn/lobster, or crab, and a method for producing the food.

When the food is a cheese-like food, an object of the present invention is to provide a cheese-like food which can be produced without a fermentation step and further which has appearance, odor, and taste similar to those of cheese.

When the food is a soft candy, an object of the present invention is to provide a soft candy which has especially a soft and smooth mouthfeel.

The present inventors have conducted intensive study by adding various fats and oils to various foods comprising soybean powder. Astonishingly, the present inventors have found that when a specific amount of a triglyceride with a medium-chain fatty acid(s) is incorporated, a food can be obtained which is reduced in beany flavor, grassy flavor, astringency, oily feeling (oiliness), oily odor, and the like, which has a good flavor, which is improved in feel-on-the-tongue, mouthfeel, milkiness, melt-in-the-mouth, smoothness, and richness, which has a high nutritive value, and further which does not require the use of any one of the specified ingredients, which are allergenic materials originated from egg, milk, wheat, buckwheat, peanut, shrimp/prawn/lobster, or crab, as an ingredient. This finding has led to the completion of the present invention. In addition, regarding the cheese-like food, the present inventors have found that, when soybean powder, serving as soybean nutrient components, an edible fat or oil, an organic acid, and optionally a thickener and a flavor are used, and further agar is used, the cheese-like food can be produced even without using any dairy ingredient such as cheese, and the cheese-like food can be produced with cheese-like appearance, odor, and taste without a fermentation step. This finding has led to the completion of the present invention.

Specifically, the present invention includes the following modes.

[1] A food comprising:

soybean powder; and

an edible fat or oil, wherein

the edible fat or oil contains a triglyceride with a medium-chain fatty acid(s) at a ratio of 50% by mass or higher relative to the mass of the edible fat or oil.

[2] The food according to the above-described [1], wherein

the triglyceride with the medium-chain fatty acid(s) is a triglyceride consisting of the medium-chain fatty acid(s).

[3] The food according to the above-described [1] or [2], wherein

the medium-chain fatty acid(s) has(have) 6 to 12 carbon atoms.

[4] The food according to any one of the above-described [1] to [3], which does not comprise any allergenic material originated from egg, milk, wheat, buckwheat, peanut, shrimp/prawn/lobster, or crab.
[5] The food according to any one of the above-described [1] to [4], wherein

the food is a gelatinous food,

the content of the soybean powder is 4 to 13% by mass relative to the total mass of the food, and

the content of the edible fat or oil is 3 to 40% by mass relative to the total mass of the food.

[6] The food according to any one of the above-described [1] to [4], wherein

the food is a liquid food,

the content of the soybean powder is 3 to 30% by mass relative to the total mass of the food, and

the content of the edible fat or oil is 5 to 20% by mass relative to the total mass of the food.

[7] The food according to any one of the above-described [1] to [4], wherein

the food is a cold sweet,

the content of the soybean powder is 0.2 to 17% by mass relative to the total mass of the food, and

the content of the edible fat or oil is 0.5 to 28% by mass relative to the total mass of the food.

[8] The food according to any one of the above-described [1] to [4], wherein

the food is a soft candy,

the content of the soybean powder is 1 to 35% by mass relative to the total mass of the food, and

the content of the edible fat or oil is 1 to 40% by mass relative to the total mass of the food.

[9] The food according to any one of the above-described [1] to [4], wherein

the food is a cheese-like food and further comprises an organic acid,

the total content of the soybean powder and the edible fat or oil is 15 to 50% by mass relative to the total mass of the food, and

the mass ratio of the soybean powder to the edible fat or oil is 7:1 to 1:7.

[10] A method for producing a food comprising soybean powder and an edible fat or oil, the method comprising the steps of:

mixing the soybean powder and the edible fat or oil with each other, wherein the edible fat or oil contains a triglyceride with a medium-chain fatty acid(s) at a ratio of 50% by mass or higher relative to the mass of the edible fat or oil; and

subjecting the mixture to a heat treatment.

[11] The method for producing a food according to the above-described [10], wherein

the triglyceride with the medium-chain fatty acid(s) is a triglyceride consisting of the medium-chain fatty acid(s).

[12] The method for producing a food according to the above-described [10] or [11], wherein

the medium-chain fatty acid(s) has(have) 6 to 12 carbon atoms.

[13] The method for producing a food according to any one of the above-described [10] to [12], wherein

the food does not comprise any allergenic material originated from egg, milk, wheat, buckwheat, peanut, shrimp/prawn/lobster, or crab.

[14] The method for producing a food according to any one of the above-described [10] to [13], wherein

the food is any one selected from the group consisting of a gelatinous food, a liquid food, a cold sweet, a soft candy, and a cheese-like food.

[15] A method for improving a flavor originated from soybean powder in a food comprising the soybean powder and an edible fat or oil, the method comprising the steps of:

mixing the soybean powder and the edible fat or oil with each other, wherein the edible fat or oil contains a triglyceride with a medium-chain fatty acid(s) at a ratio of 50% by mass or higher relative to the mass of the edible fat or oil; and

subjecting the mixture to a heat treatment.

Moreover, the present invention includes the following modes.

[21] The food according to any one of the above-described [1] to [4], wherein

the medium-chain fatty acid(s) has(have) 8 to 12 carbon atoms.

[22] The food according to any one of the above-described [1] to [4], wherein

the medium-chain fatty acid(s) has(have) 8 to 10 carbon atoms.

[23] The food according to any one of the above-described [1] to [4], wherein

the medium-chain fatty acid(s) has(have) 8 and/or 10 carbon atoms.

[24] The food according to any one of the above-described [1] to [4], wherein

the content of the soybean powder is 0.2 to 17% by mass relative to the total mass of the food, and

the content of the edible fat or oil is 0.5 to 40% by mass relative to the total mass of the food.

[25] The food according to any one of the above-described [1] to [4] and [21] to [24], further comprising a thickener.
[26] The food according to any one of the above-described [1] to [4] and [21] to [25], wherein

the food is any one selected from the group consisting of a gelatinous food, a liquid food, a cold sweet, a soft candy, and a cheese-like food.

[27] The method for producing a food according to any one of the above-described [10] to [14], wherein

the medium-chain fatty acid(s) has(have) 8 to 12 carbon atoms.

[28] The method for producing a food according to any one of the above-described [10] to [14], wherein

the medium-chain fatty acid(s) has(have) 8 to 10 carbon atoms.

[29] The method for producing a food according to any one of the above-described [10] to [14], wherein

the medium-chain fatty acid(s) has(have) 8 and/or 10 carbon atoms.

[30] The method for producing a food according to any one of the above-described [10] to [14], wherein

the content of the soybean powder is 0.2 to 17% by mass relative to the total mass of the food, and

the content of the edible fat or oil is 0.5 to 40% by mass relative to the total mass of the food.

[31] The method for producing a food according to any one of the above-described [10] to [14] and [27] to [30], comprising the step of further mixing a thickener, after the step of mixing the soybean powder and the edible fat or oil with each other but before the heat treatment step.
[32] The method according to the above-described [15], wherein

the medium-chain fatty acid(s) has(have) 8 to 12 carbon atoms.

[33] The method according to the above-described [15], wherein

the medium-chain fatty acid(s) has(have) 8 to 10 carbon atoms.

[34] The method according to the above-described [15], wherein

the medium-chain fatty acid(s) has(have) 8 and/or 10 carbon atoms.

[35] The method for producing a food according to the above-described [15], wherein

the content of the soybean powder is 0.2 to 17% by mass relative to the total mass of the food, and

the content of the edible fat or oil is 0.5 to 40% by mass relative to the total mass of the food.

[36] The method according to any one of the above-described [15] and [32] to [35], wherein

the food is any one selected from the group consisting of a gelatinous food, a liquid food, a cold sweet, a soft candy, and a cheese-like food.

Moreover, when the food of the present invention is a gelatinous food, the present invention includes the following modes.

[51] The food according to the above-described [1], wherein the food is a gelatinous food.
[52] The food according to the above-described [51], further comprising agar and/or a thickener.
[53] The food according to the above-described [51] or [52], wherein

the medium-chain fatty acid(s) has(have) 8 to 12 carbon atoms.

[54] The method for producing a food according to the above-described [10], wherein

the food is a gelatinous food.

[55] The method for producing a food according to the above-described [54], wherein

the step of mixing the soybean powder and the edible fat or oil with each other is achieved by mixing the soybean powder and the edible fat or oil, which contains the triglyceride with the medium-chain fatty acid(s), with each other at ratios of 4 to 13% by mass and 3 to 40% by mass, respectively, relative to the total amount of the food.

[56] The method for producing a food according to the above-described [54] or [55], comprising further mixing agar and/or a thickener, after the step of mixing the soybean powder and the edible fat or oil with each other but before the heat treatment step.
[57] The method for producing a food according to any one of the above-described [54] to [56], wherein

the medium-chain fatty acid(s) has(have) 8 to 12 carbon atoms.

Moreover, when the food of the present invention is a liquid food, the present invention includes the following modes.

[61] The food according to the above-described [1], wherein the food is a liquid food.
[62] The food according to the above-described [61], wherein

the medium-chain fatty acid(s) has(have) 8 to 12 carbon atoms.

[63] The method for producing a food according to the above-described [10], wherein

the food is a liquid food.

[64] The method for producing a food according to the above-described [63], wherein

the step of mixing the soybean powder and the edible fat or oil with each other is achieved by mixing the soybean powder and the edible fat or oil, which contains the triglyceride with the medium-chain fatty acid(s), with each other at ratios of 3 to 30% by mass and 5 to 20% by mass, respectively, relative to the total amount of the food.

[65] The method for producing a food according to the above-described [63] or [64], wherein

the medium-chain fatty acid(s) has(have) 8 to 12 carbon atoms.

Moreover, when the food of the present invention is a cold sweet, the present invention includes the following modes.

[71] The food according to the above-described [1], wherein

the food is a cold sweet.

[72] The food according to the above-described [71], wherein

the medium-chain fatty acid(s) has(have) 8 to 10 carbon atoms.

[73] The food according to the above-described [71] or [72], wherein

the cold sweet is an ice cream-like food.

[74] The method for producing a food according to the above-described [10], wherein

the food is a cold sweet.

[75] The method for producing a food according to the above-described [75], wherein

the mixture of the soybean powder and the edible fat or oil is a liquid mix, and

after the mixing step and the heat treatment step, the liquid mix is refrigerated while incorporating air, and then allowed to freeze.

Moreover, when the food of the present invention is a soft candy, the present invention includes the following modes.

[81] The food according to the above-described [1], wherein

the food is a soft candy.

[82] The food according to the above-described [81], further comprising a thickener.
[83] The food according to the above-described [81] or [82], wherein

the medium-chain fatty acid(s) has(have) 8 to 10 carbon atoms.

[84] The method for producing a food according to the above-described [10], wherein

the food is a soft candy.

[85] The method for producing a food according to the above-described [84], wherein

the step of mixing the soybean powder and the edible fat or oil with each other is achieved by mixing the soybean powder and the edible fat or oil, which contains the triglyceride with the medium-chain fatty acid(s), with each other at ratios of 1 to 35% by mass and 1 to 40% by mass, respectively, relative to the total amount of the food.

[86] The method for producing a food according to the above-described [84] or [85], comprising the step of further mixing a thickener after the step of mixing the soybean powder and the edible fat or oil with each other but before the heat treatment step.
[87] The method for producing a food according to any one of the above-described [84] to [86], wherein

the medium-chain fatty acid(s) has(have) 8 to 10 carbon atoms.

Furthermore, when the food of the present invention is a cheese-like food, the present invention includes the following modes.

[91] The food according to the above-described [1], wherein

the food is a cheese-like food.

[92] The food according to the above-described [91], further comprising a thickener and/or a flavor.
[93] The method for producing a food according to the above-described [10], wherein

the food is a cheese-like food.

[94] The method for producing a food according to the above-described [93], wherein

the total content of the soybean powder and the edible fat or oil is 15 to 50% by mass, and

the mass ratio of the soybean powder to the edible fat or oil is 7:1 to 1:7.

[95] The method for producing a food according to the above-described [93] or [94], comprising the step of further mixing a thickener and/or a flavor after the step of mixing the soybean powder and the edible fat or oil with each other but before the heat treatment step.

According to the present invention, soybean powder and a triglyceride with a medium-chain fatty acid(s) are added to a food such as a gelatinous food, a liquid food, a cold sweet, a soft candy, or a cheese-like food. This makes it possible to easily produce a food which has a good flavor and which is reduced in beany flavor, grassy flavor, astringency, oily feeling (oiliness), oily odor, and the like which are characteristic of soybean. Since the food of the present invention is reduced in beany flavor, grassy flavor, and astringency, which are characteristic of soybeans, and further has an excellent flavor, the food of the present invention can meet the demand of people who are not satisfied with conventional foods. In addition, since the food of the present invention comprises the triglyceride with the medium-chain fatty acid(s), the food of the present invention can be used as a food or beverage for effective energy supply or as a food or beverage for the medium-chain fatty acid(s) to exhibit their pharmacological action in a living organism. Since the food of the present invention also comprises soybean powder, the food of the present invention can serve as a high-quality protein source having an excellent amino acid score, and makes it possible to ingest nutrient components of soybeans. Moreover, the food of the present invention is significantly improved in feel-on-the-tongue, mouthfeel, milkiness, melt-in-the-mouth, smoothness, and richness. The food of the present invention makes it possible to provide a cold sweet having the above-described characteristics even without using any one of the specified ingredient, which are allergenic materials. When the food of the present invention is a soft candy, the soft candy is softer and less sticky, and has a good flavor. When the food of the present invention is a cheese-like food, the cheese-like food can be produced without a fermentation step, and hence the production time can be shortened, and the production costs can be reduced.

### DESCRIPTION OF EMBODIMENTS

Hereinafter, foods of the present invention are described one by one.

In the present invention, “foods” mean all materials which may be unprocessed ingredients or may be materials processed or semi-processed for consumption by humans, and include all materials used for producing, preparing, or processing beverages, chewing gums, and foods. However, the “foods” do not include materials used only for cosmetics, tobaccos, and/or drugs. The shape of each food may be a solid, a liquid, a gel, or the like. The food of the present invention can be preferably selected from the group consisting of a gelatinous food, a liquid food, a cold sweet, a soft candy, and a cheese-like food.

In the present invention, a “gelatinous food” is one in which soybean powder, an edible fat or oil (50% by mass or more of the fat or oil is a triglyceride with a medium-chain fatty acid(s)), and optionally water are contained as ingredients, and in which these components are solidified by an action of a gelling agent. The gelatinous food is preferably a semi-solid material, and more preferably one which is required to have slimy and smooth feel-on-the-tongue and mouthfeel with a finer texture. Specific examples of the gelatinous food include so called chilled sweets such as crème caramel, mousse, Bavarian creams, jellies, and annin tofu. In sum, the “gelatinous food” of the present invention is preferably a chilled sweet, and more preferably a crème caramel.

In addition, the “gelatinous food” in the present invention is a gel food or beverage which uses soybean powder, an edible fat or oil (50% by mass or more of the fat or oil is a triglyceride with a medium-chain fatty acid(s)), and optionally water as ingredients, and which can be produced either in a case where an allergenic material originated from egg, milk, wheat, buckwheat, peanut, shrimp/prawn/lobster, or crab, i.e., a so-called specified ingredient is used as an ingredient, or in a case where no specified ingredient is used as an ingredient.

Accordingly, the “gelatinous food” of the present invention can be provided to consumers not only as a common food, but also as a food prepared by considering allergies caused by specified ingredients.

In the present invention, a “liquid food” is not particularly limited, as long as the “liquid food” is one which contains soybean powder, an edible fat or oil (50% by mass or more of the fat or oil is a triglyceride with a medium-chain fatty acid(s)), and optionally water as ingredients, and which is provided with a good flavor by mixing and heating these constituents to reduce the beany flavor, the grassy flavor, the astringency, and the like. Specific examples of the liquid food include fluid diets, beverages, soups, stews, curries, gratin soups, soup stocks, and the like.

In the present invention, a “cold sweet” is one which contains soybean powder, an edible fat or oil (50% by mass or more of the edible fat or oil is a triglyceride with a medium-chain fatty acid(s)), and optionally water as ingredients, and which is obtained by emulsifying these constituents in an oil-in-water emulsion, and, if necessary, foaming the emulsion or refrigerating the emulsion with foaming. The cold sweet is preferably one in a solid form with plasticity. The cold sweet is preferably one required to have smooth feel-on-the-tongue and mouthfeel. The cold sweet of the present invention is such an oil-in-water emulsion food, and specific examples thereof include ice creams, puddings, custards, mousses, creams, and the like. The cold sweet is particularly preferably an ice cream or an ice cream-like food.

The above-described ice cream or ice cream-like food may be an ice cream, an ice milk, or a lacto-ice according to the classification of ice creams specified under Ministerial Ordinance on Milk and Milk products Concerning Compositional Standards, etc. (Ordinance No. 52 of the Ministry of Welfare, Dec. 27, 1951) and Fair Competition Code (Notification No. 17 of Japan Fair Trade Commission, Aug. 31, 2009). When no ingredient originated from milk is used, the ice cream or ice cream-like food may be classified into the frozen sweet according to the classification. A frozen sweet using soybean powder instead of an ingredient originated from milk can be considered as an ice cream-like food.

In the present invention, a “soft candy” is one produced by using soybean powder and an edible fat or oil (50% by mass or more of the fat or oil is a triglyceride with a medium-chain fatty acid(s)) as ingredients. According to Japan Agricultural Standards (Notification No. 1086 of The Ministry of Agriculture, Forestry and Fisheries of Japan, Jun. 4, 1973) which specify candies, candies can be roughly classified into hard candies with water contents of 6% or less, and soft candies with water contents of 6 to 200. In addition, characteristically, the former are hard, whereas the latter are soft. The both use saccharides such as table sugar and starch syrup as main ingredients.

Accordingly, the “soft candy” of the present invention refers to a candy having a water content of generally 6% by mass or higher and 20% by mass or lower after boiling down. Specifically, the soft candy may be caramel, nougat, or the like.

A “cheese-like food” of the present invention is not particularly limited, as long as the cheese-like food is a food which is produced by using soybean powder, an edible fat or oil (50% by mass or more of the fat or oil is a triglyceride with a medium-chain fatty acid(s)), and an organic acid as main ingredients, which has appearance, odor, and taste similar to those of cheese, which can be produced even when any allergenic material originated from egg, milk, wheat, buckwheat, peanut, shrimp/prawn/lobster, or crab, i.e., any specified ingredient, is not used as an ingredient, and which can be produced without a fermentation step.

Accordingly, advantageously, the “cheese-like food” of the present invention can be provided to consumers not only as a common food, but also as a food prepared by considering allergies caused by the specified ingredients.

In addition, the “cheese-like food” of the present invention has a different form from those of traditional processed soybean foods such as tofu and NATTO (fermented soybeans). Hence, it is possible to provide consumers with an opportunity to ingest soybean nutrient components in a novel form, and the “cheese-like food” of the present invention is effective also for citizens' health promotion.

Here, examples of the “allergenic materials” of the present invention include the following. Examples of materials originated from “egg” include eggs, egg yolk, egg white, and the like. Examples of materials originated from “milk” include cow's milk, cheese, butter, and the like. Examples of materials originated from “wheat” include wheat, wheat flour, wheat gluten, and the like. Examples of materials originated from “buckwheat” include buckwheat, buckwheat tea, and the like. Examples of materials originated from “peanut” include peanuts, peanut proteins, and the like. Examples of materials originated from “shrimp/prawn/lobster” include shrimps/prawns/lobsters, shrimp/prawn/lobster oils, and the like. Examples of materials originated from “crab” include crabs, crab extracts, and the like.

The “soybean powder” used in the present invention is obtained by removing the seed coats of soybeans, and crushing the soybeans without removing the fibrous material (so called Okara (soy pulp)), and then drying the crushed soybean, if necessary, by applying heat. As the “soybean powder,” a commercially available product can be used. It is possible to use either soybean powder subjected to a heat treatment, or soybean powder not subjected to a heat treatment. In addition, it is also possible to use soybean powder obtained by using, for example, a special soybean variety such as lipoxygenase-deficient soybeans as the ingredient.

Examples of commercially available products include those manufactured by The Nisshin OilliO Group, Ltd. under the trade names of “Alphaplus HS-600” and “Soya Flour NSA,” and the like.

The content of the “soybean powder” in the food of the present invention is, for example, 0.2% by mass or higher, preferably 1% by mass or higher, and more preferably 3% by mass or higher and also is, for example, 35% by mass or lower, preferably 30% by mass or lower, more preferably 17% by mass or lower, and further preferably 13% by mass or lower relative to the total mass of the food. A preferred content of the “soybean powder” is, for example, 0.2 to 30% by mass, more preferably 0.2 to 17% by mass, and further preferably 0.2 to 13% by mass.

When the present invention provides a gelatinous food, the content of the “soybean powder” in the gelatinous food is preferably 4 to 13% by mass relative to the total mass of the food. This is because when the soybean powder content is 4% by mass or higher, a sufficient richness can be obtained. In addition, when the gelatinous food with the soybean powder content being 13% by mass or lower is eaten, the graininess of the soybean powder is not perceptible, and the feel-on-the-tongue is not impaired. In addition, when the present invention provides a gelatinous food, the soybean powder content is more preferably 5 to 12% by mass, and further preferably 6 to 12% by mass.

When the present invention provides a liquid food, the content of the “soybean powder” in the liquid food is preferably 3 to 30% by mass relative to the total mass of the food. This is because when the soybean powder content is 3% by mass or higher, a sufficient richness can be obtained. Meanwhile, when the liquid food with the soybean powder content being 30% by mass or lower is ingested, the graininess of the soybean powder is not perceptible, and the feel-on-the-throat is not impaired. In addition, when the present invention provides a liquid food, the soybean powder content is more preferably 5 to 25% by mass, and further preferably 6 to 20% by mass.

When the present invention provides a cold sweet, the content of the “soybean powder” in the cold sweet is, for example, 0.2 to 17% by mass, preferably 0.5 to 15% by mass, more preferably 1 to 13% by mass, and further preferably 2 to 11% by mass relative to the total mass of the food. The soybean powder content is preferably within the above-describe range, because a cold sweet with a good richness (kokumi) and a smooth feel-on-the-tongue can be obtained.

When the present invention provides a soft candy, the content of the “soybean powder” in the soft candy is preferably 1 to 35% by mass relative to the total mass of the food. This is because when the soybean powder content is 1% by mass or higher, a sufficient richness can be obtained. Meanwhile, when the cold sweet with the soybean powder content being 35% by mass or lower is eaten, the graininess of the soybean powder is not perceptible, and the feel-on-the-tongue is not impaired. In addition, when the present invention provides a soft candy, the soybean powder content is more preferably 3 to 25% by mass, and further preferably 5 to 15% by mass.

When the present invention provides a cheese-like food, the content of the “soybean powder” in the cheese-like food is preferably 10 to 30% by mass relative to the total mass of the food. This is because when the soybean powder content is 10% by mass or higher, cheesiness can be obtained without impairment in taste such as feel-on-the-tongue, mouthfeel, and richness. Meanwhile, when the soybean powder content is 30% by mass or lower, the viscosity is not increased to an extent that the workability is impaired. Moreover, the feel-on-the-tongue, the mouthfeel, and the melt-in-the-mouth are good, and further the soybean flavor is not strong. In addition, when the present invention provides a cheese-like food, the soybean powder content is more preferably 15 to 25% by mass, and further preferably 17.5 to 22.5% by mass.

The soybean powder used in the present invention has an average particle diameter of preferably 50 μm or less and more preferably 30 μm or less to obtain a food, especially a cold sweet, with a smooth mouthfeel.

The “soybean beverage” in the present invention refers to a liquid food obtained by using soybeans as an ingredient and containing soy pulp (fibrous material). The “soybean beverage” is different from generally defined soy milks, such as plain soy milk, prepared soy milk, soy milk beverages, and soy protein beverages. This is based on the specification in Japan Agricultural Standards (JAS) stating that one obtained by using a powder of soybeans is not classified into soy milk, as Article 2 of Japan Agricultural Standards for soy milks (enacted: Nov. 16, 1981, Notification No. 1800 of The Ministry of Agriculture, Forestry and Fisheries of Japan; Final confirmation: Jul. 17, 2012, Notification No. 1679 of The Ministry of Agriculture, Forestry and Fisheries of Japan) states that “soy milk” refers to a milk-like beverage (hereinafter, referred to as “soybean soy milk liquid”) which is obtained by eluting proteins and other components from soybeans (excluding powdery or defatted ones; hereinafter, the same shall apply) with hot water or the like, and removing fibrous materials and which has a soybean solid content of 8% or higher. Specifically, in short, a soybean beverage and a soy milk are distinguished from each other by the point that the soybean beverage contains soy pulp (fibrous material), whereas soy milk does not contain soy pulp (fibrous material).

Accordingly, the “liquid foods” of the present invention include soybean beverages prepared by a special technique not to produce soy pulp, such as a soybean beverage obtained in such a manner that the seed coats of soybeans used as an ingredient are removed from the soybeans without immersion in water, and, after addition of water, the soybeans are granulated, heated, degassed, and emulsified with a homogenizer under a high pressure; a liquid food obtained by in such a manner that a fine soybean powder is emulsified and dispersed in water by using a homogenizer; and the like.

In addition, the “liquid foods” of the present invention also include soybean beverages produced under a condition where lipoxygenase, which causes the grassy flavor, is inactivated or obtained by using lipoxygenase-deficient soybeans as an ingredient to reduce the grassy flavor and the astringency contained in soybeans and to improve the flavor, and the like.

The “edible fat or oil” used in the present invention includes any edible fats and oils, as long as the fats and oils are suitable for eating. However, in the present invention, the “edible fat or oil” refers to one comprising at least a triglyceride with a medium-chain fatty acid(s) (hereinafter, this triglyceride is also referred to as “MTG”). It is desirable that the triglyceride with the medium-chain fatty acid(s) be generally 50% by mass or more, preferably 70% by mass or more, more preferably 80% by mass or more, and further preferably 90% by mass or more relative to the total mass of the edible fat or oil for the edible fat or oil to be free from soybean flavor, oily odor, and oily feeling. In addition, it is the most desirable that the entirety (100% by mass) of the edible fat or oil is the above-described triglyceride.

Here, the expression “with a medium-chain fatty acid(s)” means that at least one of the three fatty acid residues constituting a triglyceride is a medium-chain fatty acid residue. Examples of medium-chain fatty acids suitable as constituent fatty acids include medium-chain fatty acids having 6 to 12 carbon atoms, preferably having 8 to 12 or 6 to 10 carbon atoms, more preferably 8 to 10 carbon atoms, and further preferably 8 and/or 10 carbon atoms. The triglyceride may be a triglyceride whose constituent fatty acids are only medium-chain fatty acids having 6 to 12 carbon atoms (hereinafter, this triglyceride is also referred to as “MCT”) or a triglyceride whose constituent fatty acids are only medium-chain fatty acids having 8 to 12 carbon atoms. The triglyceride may be a mixed triglyceride containing one or more medium-chain fatty acids having, for example, 6 to 12 carbon atoms and one or more other fatty acids as the constituent fatty acids. Here, the position at which each medium-chain fatty acid is bonded to glycerin is not particularly limited. Moreover, when the triglyceride is a mixed triglyceride, some of the constituent fatty acids may be fatty acids other than those having 6 to 12 carbon atoms, and, for example, long-chain fatty acids having 14 or more carbon atoms may be contained. Here, the medium-chain fatty acids having 6 to 12 carbon atoms are preferably linear-chain saturated fatty acids.

When the food of the present invention is any one of a gelatinous food, a liquid food, and a cheese-like food, suitable numbers of the carbon atoms are 8 to 12. When the food of the present invention is a cold sweet, suitable numbers of carbon atoms are 6 to 10. When the food of the present invention is a soft candy, suitable numbers of the carbon atoms are 8 to 10.

When the food of the present invention is a cold sweet, the medium-chain fatty acid(s) in the triglyceride with the medium-chain fatty acid(s) are preferably a fatty acid(s) having 6 to 10 carbon atoms. The edible fat or oil used in the present invention contains the triglyceride containing the medium-chain fatty acid(s) as the constituent fatty acid(s). Here, the triglyceride may be a triglyceride whose constituent fatty acid(s) is (are) only a medium-chain fatty acid(s) having 6 to 10 carbon atoms, or may be a mixed triglyceride containing one or more medium-chain fatty acids having 6 to 10 carbon atoms and one or more other fatty acids as the constituent fatty acids. Here, the position at which each medium-chain fatty acid is bonded to glycerin is not particularly limited. In addition, when the triglyceride is a mixed triglyceride, some of the constituent fatty acids may be fatty acids other than those having 6 to 10 carbon atoms. For example, the mixed triglyceride may contain fatty acids having 12 or more carbon atoms. Here, the medium-chain fatty acids having 6 to 10 carbon atoms are preferably linear-chain saturated fatty acids.

In addition, the above-described triglyceride used in the present invention may be, for example, a mixture in which multiple fats or oils of different molecular species are mixed with each other, such as a mixture of tri(octanoyl) glyceride and tri(decanoyl) glyceride. The triglyceride may be in any form such as a liquid form, a solid from, or a powder from. The triglyceride with the medium-chain fatty acid(s) is preferably a triglyceride whose constituent fatty acids consist of a medium-chain fatty acid(s) having 6 to 12 carbon atoms, and preferably 6 to 10 or 8 to 12 carbon atoms. Especially, a triglyceride whose constituent fatty acids consist of a medium-chain fatty acid(s) having 8 and/or 10 carbon atoms is more preferable. Preferred examples include an edible fat or oil in which a product “MCT-C10R” which is manufactured by The Nisshin OilliO Group, Ltd. under and which is a triglyceride whose constituent fatty acids consist of medium-chain fatty acids having 8 and 10 carbon atoms is incorporated, and the like.

The content of the “edible fat or oil” in the food of the present invention is, for example, 0.5% by mass or higher, preferably 1% by mass or higher, and more preferably 3% by mass or higher, and also is, for example, 40% by mass or lower, preferably 28% by mass or lower, and more preferably 20% by mass or lower, relative to the total mass of the food. A preferred range of the content of the “edible fat or oil” is, for example, 0.5 to 40% by mass, preferably 1 to 28% by mass, and more preferably 3 to 20% by mass.

When the present invention provides a gelatinous food, the content of the “edible fat or oil” in the gelatinous food is preferably 3 to 40% by mass relative to the total mass of the food. This is because when the edible fat or oil content is 3% by mass or higher, the softness is sufficient, and an effect of reducing the soybean flavor can be obtained sufficiently. In addition, when the gelatinous food with the edible fat or oil content being 40% by mass or lower is eaten, no oily feeling is perceived, and the kokumi of soybean is not reduced. In addition, the edible fat or oil content is more preferably 5 to 35% by mass, and further preferably 7 to 30% by mass.

When the present invention provides a liquid food, the content of the “edible fat or oil” in the liquid food is preferably 5 to 20% by mass relative to the total mass of the food. This is because when the edible fat or oil content is 5% by mass or higher, the richness (kokumi) is sufficient, and an effect of reducing the soybean flavor is obtained sufficiently. Meanwhile, when the liquid food with the edible fat or oil content being 20% by mass or lower is eaten, no oily feeling is perceived, and the kokumi of soybean is not reduced. In addition, the edible fat or oil content is more preferably 6 to 17.5% by mass, and further preferably 7 to 15% by mass.

When the present invention provides a cold sweet, the content of the “edible fat or oil” in the cold sweet is 0.5 to 28% by mass, preferably 1 to 26% by mass, more preferably 3 to 24% by mass, and further preferably 5 to 22% by mass relative to the total mass of the food. An edible fat or oil content within the above-describe range is preferable, because a rich cold sweet can be obtained with reduced oily feeling and reduced unpreferable flavor of soybean such as the grassy flavor and the astringency.

When the present invention provides a soft candy, the content of the “edible fat or oil” in the soft candy is preferably 1 to 40% by mass relative to the total mass of the food. This is because when the edible fat or oil content is 1% by mass or higher, the softness is sufficient, the soft candy does not stick to the teeth or the package paper, and an effect of reducing the soybean flavor is obtained sufficiently. Meanwhile, when the soft candy with the edible fat or oil content being 40% by mass or lower is eaten, no oily feeling is perceived, and the kokumi of soybean is not reduced. In addition, the edible fat or oil content is more preferably 3 to 30% by mass, and further preferably 5 to 25% by mass.

When the present invention provides a cheese-like food, the content of the “edible fat or oil” in the cheese-like food is preferably 5 to 40% by mass relative to the total mass of the food. This is because when the edible fat or oil content is 5% by mass or higher, the softness is sufficient, and an effect of reducing the soybean flavor is obtained sufficiently. Meanwhile, when the cheese-like food with the edible fat or oil content being 40% by mass or lower is eaten, no oily feeling is perceived, and the kokumi of soybean is not reduced. In addition, the edible fat or oil content is more preferably 10 to 30% by mass, and further preferably 15 to 25% by mass.

In addition, when the present invention provides a cheese-like food, the soybean powder and the edible fat or oil both constitute solid components, and the amounts of these components added are limited, naturally. Specifically, it is preferable to add the soybean powder as much as possible because of the high nutritive value, as described above. In this respect, as described later, when the content is 35% by mass or lower, a sufficient amount of the edible fat or oil can be added, without impairing the workability. On the other hand, it is necessary to add a certain amount of the edible fat or oil to obtain a cheese-like food free from the soybean flavor. Moreover, the upper limit of the amount of the edible fat or oil added is naturally limited to obtain a cheese-like food free from oily odor and oily feeling. The total content of the “soybean powder” and the “edible fat or oil” in the cheese-like food is preferably 15 to 50% by mass, more preferably 20 to 50% by mass, and further preferably 30 to 40% by mass relative to the total mass of the food. In addition, the mass ratio of the “soybean powder”:the “edible fat or oil” is, for example, 7:1 to 1:7, preferably 6:1 to 1:6, and more preferably 5:1 to 1:5.

The triglyceride with a medium-chain fatty acid(s) which is contained in the liquid food of the present invention and whose constituent fatty acids contain medium-chain fatty acids having 6 to 12 carbon atoms can be produced by a known conventional method. For example, the triglyceride can be produced by a dehydration condensation of fatty acids having 6 to 12 carbon atoms and glycerol in the presence of a catalyst or preferably in the absence of a catalyst, preferably under reduced pressure with heating to 50 to 250° C. and more preferably 120 to 180° C.

Here, the catalyst is not particularly limited, and, it is possible to use, for example, an acid catalyst, a base catalyst, or the like used for ordinary transesterification. The reduced pressure is, for example, 0.01 to 100 Pa, preferably 0.05 to 75 Pa, and more preferably 0.1 to 50 Pa. Here, the water content in the system is preferably as low as possible, and is further preferably 0.2% by weight or lower.

The edible fat or oil used in the liquid food of the present invention may further comprise any other edible fat or oil ingredients, as long as the content of the triglyceride with the medium-chain fatty acid(s) having 8 to 12 carbon atoms falls within the above-described specific range (50% by mass or more of the edible fat or oil incorporated). For example, it is possible to further use any ones of coconut oil, palm kernel oil, palm oil, palm oil fractions (palm olein, palm super olein, and the like), shea butter, shea butter fractions, sal fat, sal fat fractions, illipe butter, soybean oil, rapeseed oil, cottonseed oil, safflower oil, sunflower oil, rice bran oil, corn oil, sesame oil, olive oil, butterfat, cocoa butter, and the like, mixture oils of any of them, processed fats or oils of any of them, and the like.

In the present invention, various sub ingredients such as a sweetener, a thickener, and an emulsifier may be contained according to the type of the food. Hereinafter, sub ingredients usable in the present invention are described.

As a sweet material serving as the “sweetener” usable as a sub ingredient in the present invention, any material having a sweet taste can be used. Examples of the sweet material include saccharides such as sucrose, fructose, and glucose, sugar alcohols such as xylitol, sorbitol, maltitol, erythritol, and mannitol, high-intensity sweeteners such as acesulfame potassium, sucralose, neotame, saccharin, aspartame, stevia, and glycyrrhizin, and the like. One of these sweet materials may be used alone, or two or more thereof may be used in combination. The amount of the sweetener such as the above-described saccharides may be an amount added to a common food, and is generally 0.1 to 5% by mass, although it depends on the type of the sweetener used. The amount in a soft candy may be an amount added to an ordinary soft candy, and is generally 20 to 80% by mass relative to the solid content.

“Thickeners” usable as sub ingredients in the present invention include, but are not particularly limited to, pectin, locust bean gum, soybean polysaccharides, guar gum gelatin, konjak mannan, xanthan gum, tamarind gum, carrageenan, propylene glycol, carboxymethyl cellulose, gellan gum, tara gum, tamarind seed gum, psyllium seed gum, gum arabic, curdlan, pullulan, sodium alginate, gum tragacanth, karaya gum, VEEGUM, and the like. One of these thickeners may be used alone or two or more thereof may be used as a mixture. Of these thickeners, it is preferable to use gelatin for a soft candy, because a poorly water-soluble complex is easily formed, so that the chewability is increased. In addition, when a thickener is used for a cheese-like food, the thickener can be added to make the taste of the cheese-like food similar to that of cheese. It is preferable to use pectin as a thickener for a cheese-like food. It is possible to use either HM pectin with a solid cturonic acid content of 50% or higher or LM pectin with a methoxylated galacturonic acid content of lower than 50%.

The amount of the thickener may be an amount added to a common food, and generally accounts for 0.01 to 5% by mass of the solid content. The amount in a soft candy may be an amount added to an ordinary soft candy, and generally accounts for 0.1 to 10% by mass of the solid content.

Examples of “emulsifiers” usable as sub ingredients in the present invention include glycerin fatty acid esters, organic acid monoglycerides, polyglycerin fatty acid esters, propylene glycol fatty acid esters, polyglycerin condensed ricinoleic acid esters, sorbitan fatty acid esters, sucrose fatty acid esters, lecithins, enzymatically decomposed lecithins, and the like. One of these emulsifiers may be used alone or a combination thereof may be used. The amount of the emulsifier may be an amount added to a common food, and generally accounts for 0.1 to 5% by mass of the solid content. Especially when the food is a cold sweet, examples of the emulsifiers include sucrose fatty acid esters, propylene glycol fatty acid esters, sorbitan fatty acid esters, glycerin fatty acid esters, polyglycerin fatty acid esters, organic acid monoglycerides, lecithins, and the like. The emulsifier is preferably contained at 2% by mass or less in the cold sweet of the present invention.

Examples of “starches” usable as sub ingredients in the present invention include, but are not particularly limited to, dextrins, corn starch, wheat starch, sago starch, potato starch, sweet potato starch, rice starch, waxy corn starch, tapioca starch, mung bean starch, heat-moisture treated starch, cross-linked starch, hydroxypropylated starch, any other types of processed starches, and the like. One of these starches may be used alone, or two or more thereof may be used in combination. The amount of the starch may be an amount added to a common food, and is generally 0.1 to 10% by mass.

Examples of “stabilizers” usable as sub ingredients in the present invention include gums such as guar gum, locust bean gum, xanthan gum, gellan gum, and gum arabic; corn starch, carrageenan, sodium alginate, CMC, fine cellulose, gelatin, agar, pectin, and the like, as well as salts such as phosphoric acid salts. It is preferable that the food, especially, the cold sweet of the present invention contains 2% by mass or less of the stabilizer.

Examples of “dairy products” usable as sub ingredients in the present invention include cow's milk, skim milk, fresh cream, butter, skim milk powder, whole milk powder, sweetened condensed whole milk, sweetened skim milk powder, evaporated milk, and the like. In addition, the above-described saccharides include table sugar, glucose, fructose, high-fructose corn syrup, starch syrup, dried glucose syrup, dextrins, and the like. The above-described taste agents include cocoa mass, cocoa powder, fruit juice, fruit pulp, and the like.

“Flavors” usable as sub ingredients in the present invention include commercially available products. Especially, to the cheese-like food of the present invention, a “flavor” can be added to make the odor of the cheese-like food similar to that of cheese. The flavor used is preferably a cheese flavor, but any flavor with any odor can be used, as long as the flavor can modify the odor to an odor similar to that of cheese, such as a milk flavor or a butter flavor.

The content of the “flavor” in the food may be adjusted in relation to the desired odor intensity of the food, and, for example, 0.01 to 1% by mass of the “flavor” can be added.

The food of the present invention can further comprise water. The amount of water can be set, according to the nature of each food, to an amount known in the field of the food. For example, the amount of water is 30 to 85% by mass, more preferably 35 to 80% by mass, and further preferably 40 to 75% by mass. However, some foods such as soft candies do not have to contain much water.

When the food of the present invention is a gelatinous food, it is also possible to use ingredients generally incorporated in gelatinous foods, in addition to the above-described ingredients. Specifically, it is possible to use starch, modified starch, dextrins, soy proteins, cellulose, derivatives thereof, fruits, meats, seafood, flavors, coloring agents, preservatives, eggs, dairy products such as cow's milk and cheese, nuts such as almond, condiments such as common salt and pepper, and the like.

When the food of the present invention is a cold sweet, it is possible to use water, emulsifiers, stabilizers, dairy products, saccharides, flavors, taste agents, and other sub ingredients generally used for cold sweets, and the like. The water content in the cold sweet of the present invention is preferably 30 to 85% by mass, more preferably 35 to 80% by mass, and further preferably 40 to 75% by mass.

When the food of the present invention is a liquid food, it is possible to use ingredients generally incorporated in liquid foods, in addition to the above-described ingredients. Specifically, it is possible to use cellulose, derivatives thereof, fruits, meats, seafood, flavors, coloring agents, preservatives, eggs, egg yolk, dairy products such as cow's milk and cheese, nuts such as almond, condiments such as common salt and pepper, and the like.

When the food of the present invention is a soft candy, it is possible to use ingredients generally incorporated in soft candies, in addition to the above-described ingredients. Specifically, it is possible to use dextrins, soy proteins, cellulose, derivatives thereof, fruits, meats, seafood, flavors, coloring agents, preservatives, eggs, dairy products such as cow's milk and cheese, nuts such as almond, condiments such as common salt and pepper, and the like. If necessary, it is possible to add, as appropriate, other ingredients such as flavors, acidulants, coloring agents, condiments, fruit juice, fruit pulp, dairy products, and extracts to the soft candy.

When the food of the present invention is a cheese-like food, it is necessary to adjust the sour taste by adding an “organic acid” to make the taste of the cheese-like food similar to that of cheese. It is possible to use a commercially available product as the “organic acid” used in the present invention. Examples of the organic acid used include citric acid, malic acid, fumaric acid, tartaric acid, gluconic acid, adipic acid, succinic acid, lactic acid, and the like. One or two or more of the organic acids can be used.

The content of the “organic acid” in the cheese-like food may be adjusted in relation to the desired intensity of the sour taste of the cheese-like food, and, for example, it is possible to add 0.1 to 3% by mass of the organic acid.

When the food of the present invention is a cheese-like food, “agar” can be added to make the taste of the cheese-like food similar to that of cheese. A commercially available product can be used as the “agar” used in the present invention. From the viewpoint of the workability, it is preferable to use highly-soluble agar.

The content of the “agar” in the cheese-like food is preferably 0 to 1.5% by mass, and more preferably 0 to 1% by mass. This is because when the content of the agar exceeds 1.5% by mass, the melt-in-the-mouth becomes poor.

Even when the content of the agar in the cheese-like food is 0% by mass, the cheese-like food of the present invention can be obtained, as described above. However, to obtain a harder cheese-like food, it is preferable to add agar, and the amount of the agar added is preferably 0.5 to 1% by mass.

When the food of the present invention is a cheese-like food, it is also possible to use ingredients other than the above-described ingredients. Specifically, it is possible to use starches, modified starches, dextrins, emulsifiers, soy proteins, cellulose, derivatives thereof, fruits, meats, seafood, coloring agents, preservatives, dairy products such as cheese, nuts such as almond, condiments such as common salt and pepper, and the like.

The food of the present invention can be produced either in a case where an allergenic material originated from egg, milk, wheat, buckwheat, peanut, shrimp/prawn/lobster, or crab, i.e., a so-called specified ingredient is used as an ingredient, or in a case where no specified ingredient is used as an ingredient. Accordingly, the food of the present invention can be provided to the consumers as not only a common food, but also a food prepared by considering allergies caused by specified ingredients.

Note, however, that when a food not using, as ingredients, any allergenic materials originated from egg, milk, wheat, buckwheat, peanut, shrimp/prawn/lobster, or crab, i.e., any of the so-called specified ingredients is produced, it is necessary to use ingredients not containing any allergenic materials originated from egg, milk, wheat, buckwheat, peanut, shrimp/prawn/lobster, or crab as the other ingredients.

Hereinafter, a method for producing a food of the present invention is described step by step.

The food comprising the soybean powder and the edible fat or oil of the present invention can be produced by a known conventional method. A specific method for producing the food comprises the steps of: mixing the soybean powder and the edible fat or oil with each other, wherein the edible fat or oil contains a triglyceride with a medium-chain fatty acid(s) at a ratio of 50% by mass or higher relative to the mass of the edible fat or oil; and subjecting the mixture to a heat treatment. Here, specific definitions of the “soybean powder,” the “edible fat or oil,” the “triglyceride with a medium-chain fatty acid(s),” and the like and preferred ranges thereof are the same as described above. Moreover, the method may further comprise the step of further mixing the above-described sub ingredients, such as the thickener, and the like after the step of mixing the soybean powder and the edible fat or oil with each other but before the heat treatment step. The step of adding the sub ingredients and the like does not necessarily have to be conducted between the mixing step and the heat treatment step, but may be conducted before or after these steps.

Hereinafter, specific production examples of foods are described; however, the following description is applicable not only to specific foods such as a gelatinous food, but generally to the foods of the present invention.

First, the gelatinous food of the present invention can be produced as follows. Specifically, a solution mixture is prepared by mixing the above-described ingredients, including the soybean powder, the edible fat or oil, and the like, together by using a mixer such a homomixer or the like. The solution mixture is heated to 90° C. or higher, preferably 90 to 100° C., and more preferably 92 to 98° C., and then filled into a container, followed by cooling. In this manner, the gelatinous food can be produced. Note that, regarding the amounts of the ingredients used, the gelatinous food can be produced by employing the above-described amounts of the ingredients used.

More specifically, first, a solution mixture is prepared by introducing water and the other ingredients into a mixing container and mixing them together by using a homomixer. The use of hot water at 90° C. or higher as the water here improves the efficiency in terms of the dissolution of the ingredients. The solution mixture heated to 90° C. or higher is filled into a container such as a plastic cup, and then cooled. In this manner, the gelatinous food can be produced.

The temperature to which the gelatinous food is cooled is preferably 1 to 40° C. The gelatinous food may be allowed to cool at room temperature (15° C. to 25° C.). Alternatively, the gelatinous food may be first moderately cooled at room temperature and then cooled in a refrigerator, or may be cooled in a refrigerator immediately after the temperature reaches 90° C. or higher.

The cold sweet of the present invention can be produced according to an ordinary method for producing a cold sweet. For example, a mix is prepared according to an ordinary method for producing an oil-in-water emulsion. Specifically, an oil phase and a water phase are prepared by using 0.2 to 17% by mass of soybean powder, 0.5 to 28% by mass of an edible fat or oil containing a triglyceride with a medium-chain fatty acid(s) at a ratio of 50% by mass or higher, and, if necessary, water, an emulsifier, a stabilizer, a dairy product, a saccharide, other sub ingredients, and the like which are generally used for cold sweets. Then, the oil phase and the water phase are subjected to a homogenizer, and, if necessary, subjected to a sterilization process and aging. Further, if necessary, a flavor, a taste agent, and the like are added to the mix. Then, the mix is refrigerated, while air is being introduced into the mix, followed by a freezing and solidification step. In this manner, the cold sweet can be produced.

Various methods can be used to prepare the soft candy of the present invention. For example, the soft candy can be produced by the following method. Specifically, table sugar and starch syrup serving as main ingredients are blended according to a predetermined formula, and the mixture is boiled down in a pot with stirring under heating, until the temperature reaches 100 to 130° C. Subsequently, a fat or oil is added, and the resultant mixture is further stirred at 60 to 90° C. This boiled-down mixture is transferred to a mixer, and saccharide ingredients are added to a gelatin solution prepared by dissolution under heating, followed by stirring at 60 to 95° C. Then, if necessary, an acidulant, a flavor, and the like are added, followed by stirring at 50 to 80° C. The ingredient solution in which all the components are mixed together and dissolved is heated at normal pressure or reduced pressure, and boiled down, until the water content reaches a desired water content of about 5 to 15%. The soft candy material boiled down is taken out of the mixer, and cooled and solidified at 5 to 30° C. into a plate-shaped material having a suitable thickness. This plate-shaped material is cut into pieces with a suitable size. In this manner, a desired soft candy can be obtained.

The cheese-like food of the present invention can be produced by mixing the above-described ingredients together by using a mixer or the like, followed by a heat treatment. By the heat treatment, sterilization can be achieved, and the formation of the gel is promoted, so that the shape retainability of the cheese-like food can be improved. Regarding the conditions of the heat treatment, for example, a method in which the heating is conducted at 80 to 100° C. for 30 to 60 minutes or the like may be employed.

In a specific example of the production method, first, water and soybean powder are placed in a mixing container, and mixed together at normal temperature by using a mixer. Then, an edible fat or oil is added, followed by mixing. Then, common salt, an organic acid, and a flavor are added, followed by further mixing. After that, agar and a thickener are added, followed by mixing. The obtained mixture is subjected to a heat treatment at 90° C. for 30 minutes. In this manner, the cheese-like food can be produced.

The cheese-like food can take various shapes, and the shape is, for example, a sheet shape, a block shape, a stick shape, a spherical shape, or the like.

In addition, when a food not using, as ingredients, any allergenic materials originated from egg, milk, wheat, buckwheat, peanut, shrimp/prawn/lobster, or crab, i.e., any of the so-called specified ingredients is produced, it is only necessary to use ingredients not containing any allergenic materials originated from egg, milk, wheat, buckwheat, peanut, shrimp/prawn/lobster, or crab as the other ingredients.

Hereinafter, a method for improving a flavor originated from soybean powder in a food comprising the soybean powder and an edible fat or oil of the present invention is described step by step.

The method for improving a flavor originated from soybean powder in a food comprising the soybean powder and an edible fat or oil of the present invention comprises the steps of: mixing the soybean powder and the edible fat or oil with each other, wherein the edible fat or oil contains a triglyceride with a medium-chain fatty acid(s) at a ratio of 50% by mass or higher relative to the mass of the edible fat or oil; and

subjecting the mixture to a heat treatment.

Here, the specific definitions of the “soybean powder,” the “edible fat or oil,” the “triglyceride with a medium-chain fatty acid(s)”, and the like, preferred ranges thereof, and the point that the step of mixing sub ingredients may be further included are the same as those in the description of the food and the method for producing the food of the present invention provided above.

### EXAMPLES

Next, the present invention is described in further detail based on Examples and Comparative Examples; however, the present invention is not limited thereto at all.

In the following description, “%” means % by mass, unless otherwise noted.

### [1] Gelatinous Foods

<Ingredients>

Soybean powder used was one manufactured by The Nisshin OilliO Group, Ltd. under the trade name of “Alphaplus HS-600.”

A triglyceride with a medium-chain fatty acid(s) used as an edible fat or oil was a triacylglycerol (manufactured by The Nisshin OilliO Group, Ltd. under the trade name of MCT-C10R and hereinafter also referred to as MCT1) consisting of only medium-chain fatty acids having 8 and 10 carbon atoms. In the triacylglycerol, the fatty acids constituting the triglyceride were n-octanoic acid (having 8 carbon atoms) and n-decanoic acid (having 10 carbon atoms), and the ratio (mass ratio) of the fatty acids constituting the triglyceride was as follows: n-octanoic acid:n-decanoic acid=30:70.

Canola oil used as an edible fat or oil was one manufactured by The Nisshin OilliO Group, Ltd. under the trade name of Nisshin Canola Oil. In the canola oil, the fatty acids constituting the triglyceride were palmitic acid (having 16 carbon atoms), oleic acid (having 18 carbon atoms), linoleic acid (having 18 carbon atoms), and others, and the ratio (mass ratio) of the fatty acids constituting the triglyceride was as follows:palmitic acid:oleic acid:linoleic acid:others=approximately 4:61:20:15. In the canola oil, the content of triglycerides containing a medium-chain fatty acid(s) was 0% by mass.

Commercially available products were used as the other ingredients including a flavor (custard flavor), salt, a sweetener (table sugar), agar, and thickeners (K carrageenan, locust bean gum, guar gum, and xanthan gum).

### Production of Gelatinous Foods

### Reference Examples 1 to 4

Reference Examples 1 to 4 were preliminary ones conducted in view of an object of the present invention to determine the lower limit and the upper limit of the acceptable amount of the soybean powder contained in a gelatinous food. The amount of the soybean powder was changed by adjusting the amounts of table sugar, agar, the thickeners (K carrageenan, locust bean gum, guar gum), and water incorporated.

In Reference Examples 1 to 4, creme caramel-like foods which were gelatinous foods not containing any allergenic materials originated from egg, milk, wheat, buckwheat, peanut, shrimp/prawn/lobster, or crab were produced according to the formulae shown in Table 1. More specifically, first, the ingredients shown in Table 1 were placed in a mixing container, and mixed by using a homomixer (3000 rpm) for 1 minute (the temperature during the mixing was 92° C.) to obtain a solution mixture. The obtained solution mixture was placed in plastic cups, and the cups containing the solution mixture was cooled overnight in a refrigerator at 4° C. to obtain each gelatinous food.

TABLE 1
Formulae of gelatinous foods (% by mass)

| | Ref. | Ref. | Ref. | Ref. |
|---|---|---|---|---|
| | Ex. 1 | Ex. 2 | Ex. 3 | Ex. 4 |
| Soybean powder | 3.00% | 6.00% | 12.00% | 15.00% |
| Custard flavor | 0.13% | 0.13% | 0.13% | 0.13% |
| Salt | 0.13% | 0.13% | 0.13% | 0.13% |
| Sugar | 8.15% | 8.14% | 8.13% | 8.11% |
| Agar | 0.14% | 0.13% | 0.12% | 0.10% |
| κ carrageenan | 0.08% | 0.07% | 0.07% | 0.06% |
| Locust bean gum | 0.06% | 0.05% | 0.05% | 0.04% |
| Guar gum | 0.03% | 0.03% | 0.03% | 0.02% |
| Xanthan gum | 0.01% | 0.01% | 0.01% | 0.01% |
| Hot water at 98° C. | 88.27% | 85.30% | 79.33% | 76.40% |
| Total | 100.00% | 100.00% | 100.00% | 100.00% |

<Method for Evaluating Gelatinous Foods>

The tastes of the thus produced gelatinous foods of Reference Examples 1 to 4 were evaluated by nine well-experienced panelists. Specifically, the gelatinous foods were evaluated in terms of six items, i.e., appearance, soybean flavor, richness, smoothness, oily feeling, and overall evaluation based the evaluation criteria shown below (scored to one decimal place), and the average value of the evaluation scores given by the nine panelists was obtained for each of the evaluation items. The evaluation scores were rounded to one decimal place. When the average value of the overall evaluation was 3.5 or higher, the gelatinous food was determined to be acceptable. Table 2 shows the taste evaluation results. Method for Scoring Appearance

5.0 points: Appearance completely the same as that of crème caramel

4.0 points: Appearance similar to that of crème caramel

3.0 points: Appearance slightly similar to that of crème caramel

2.0 points: Appearance different from that of crème caramel

1.0 points: Appearance completely different from that of crème caramel

### Method for Scoring Soybean Flavor

5.0 points: Completely imperceptible

4.0 points: Almost imperceptible

3.0 points: Slightly perceptible

2.0 points: Perceptible

1.0 points: Clearly perceptible

### Method for Scoring Richness

5.0 points: Clearly perceptible

4.0 points: Perceptible

3.0 points: Slightly perceptible

2.0 points: Almost imperceptible

1.0 points: Completely imperceptible

### Method for Scoring Smoothness

5.0 points: Clearly perceptible

4.0 points: Perceptible

3.0 points: Slightly perceptible

2.0 points: Almost imperceptible

1.0 points: Completely imperceptible

### Method for Scoring Oily Feeling

5.0 points: Completely imperceptible

4.0 points: Almost imperceptible

3.0 points: Slightly perceptible

2.0 points: Perceptible

1.0 points: Clearly perceptible

### Method for Scoring Overall Evaluation

5.0 points: Tastes good with good flavor

4.0 points: Tastes good despite slight lack of good flavor

3.0 points: Suitable as commercial product despite lack of good flavor

2.0 points: Unsuitable as commercial product, because of the presence of unpleasant flavor

1.0 points: Uneatable because of strong unpleasant flavor

TABLE 2
Evaluation results

| | Ref. | Ref. | Ref. | Ref. |
|---|---|---|---|---|
| | Ex. 1 | Ex. 2 | Ex. 3 | Ex. 4 |
| Appearance | 1.4 | 2.9 | 3.9 | 4.2 |
| Soybean flavor | 4.4 | 3.7 | 2.7 | 2.1 |
| Richness | 1.9 | 2.9 | 3.3 | 4.0 |
| Smoothness | 3.0 | 2.8 | 3.0 | 2.3 |
| Oily feeling | 3.8 | 3.7 | 3.9 | 3.8 |
| Overall evaluation | 1.9 | 3.5 | 3.6 | 2.4 |

As can be seen from the results shown in Table 2, the results of the investigation of the acceptable amount of the soybean powder contained in a gelatinous food showed a tendency that the appearance became closer to that of crème caramel, and the soybean flavor and the richness increased with the increase in soybean powder content. In addition, the smoothness decreased at the soybean powder content of Reference Example 4.

In addition, it was found that the gelatinous foods of

Reference Examples 2 and 3 were acceptable with the scores of the item of overall evaluation being 3.5 or higher, whereas the gelatinous foods of Reference Examples 1 and 4 were unacceptable with the scores of the item of overall evaluation being lower than 3.5.

Considering the above-described results, the lower limit and the upper limit of the soybean powder content were determined to be 6% by mass (Reference Example 2) and 12% by mass (Reference Example 3), respectively.

Reference Examples 1 to 4 clarified the soybean powder content usable in a gelatinous food. Next, the types of edible fat or oil and the acceptable amounts thereof contained in a gelatinous food were examined.

### Production of Gelatinous Foods

### Examples 1 and 2 and Comparative Examples 1 and 2

In Examples 1 and 2 and Comparative Examples 1 and 2, the types of edible fats or oils and the acceptable amounts thereof contained in a gelatinous food were investigated with the amount of the soybean powder being kept constant in view of an object of the present invention. The amount of the edible fat or oil incorporated was changed by adjusting the amount of water incorporated.

In the production of Examples 1 and 2 and Comparative Examples 1 and 2, crème caramel-like foods which were gelatinous foods not containing any allergenic materials originated from egg, milk, wheat, buckwheat, peanut, shrimp/prawn/lobster, or crab were produced according to the formulae shown in Table 3 in the same manner as in <Production of Gelatinous Foods> described above.

TABLE 3
Formulae of gelatinous foods (% by mass)

| | | Comp. | | Comp. |
|---|---|---|---|---|
| | Ex. 1 | Ex. 1 | Ex. 2 | Ex. 2 |
| Soybean powder | 12.00% | 12.00% | 12.00% | 12.00% |
| Canola oil | — | 3.00% | — | 15.00% |
| MCT1 | 3.00% | — | 15.00% | — |
| Custard flavor | 0.13% | 0.13% | 0.13% | 0.13% |
| Salt | 0.13% | 0.13% | 0.13% | 0.13% |
| Sugar | 8.13% | 8.13% | 8.13% | 8.13% |
| Agar | 0.12% | 0.12% | 0.12% | 0.12% |
| κ carrageenan | 0.07% | 0.07% | 0.07% | 0.07% |
| Locust bean gum | 0.05% | 0.05% | 0.05% | 0.05% |
| Guar gum | 0.03% | 0.03% | 0.03% | 0.03% |
| Xanthan gum | 0.01% | 0.01% | 0.01% | 0.01% |
| Hot water at 98° C. | 76.33% | 76.33% | 64.33% | 64.33% |
| Total | 100.00% | 100.00% | 100.00% | 100.00% |

In Examples 1 and 2 and Comparative Examples 1 and 2, the same sensory evaluation as in <Method for Evaluating Gelatinous Foods> described above was conducted.

TABLE 4
Evaluation results

| | | Comp. | | Comp. |
|---|---|---|---|---|
| | Ex. 1 | Ex. 1 | Ex. 2 | Ex. 2 |
| Appearance | 4.3 | 4.6 | 3.6 | 4.1 |
| Soybean flavor | 3.0 | 2.8 | 4.0 | 3.6 |
| Richness | 3.8 | 3.2 | 4.3 | 3.8 |
| Smoothness | 3.6 | 2.9 | 4.0 | 3.3 |
| Oily feeling | 3.6 | 3.3 | 2.7 | 2.3 |
| Overall evaluation | 4.7 | 3.4 | 4.3 | 3.3 |

As can be seen from the results shown in Table 4, there was a tendency that the richness and the smoothness were increased, while the soybean flavor and the oily feeling were reduced in Examples 1 and 2, in comparison with Comparative Examples 1 and 2.

Regarding Example 1 and Comparative Example 1, in each of which an edible fat or oil was contained at 3% by mass, the overall evaluation of Example 1 was better than that of Comparative Example 1. Meanwhile, regarding Example 2 and Comparative Example 2, in each of which an edible fat or oil was contained at 15% by mass, the overall evaluation of Example 2 was better than that of Comparative Example 2. Hence, it has been found that MCT1 is better than canola oil, when these edible oils are contained in gelatinous foods at the same concentration.

On the other hand, the investigation for the acceptable amount of an edible fat or oil contained in a gelatinous food in a case where the contents of the custard flavor, salt, table sugar, agar, and thickeners (K carrageenan, locust bean gum, guar gum, and xanthan gum), which were the components other than the soybean powder and the edible fat or oil, took the same values, and the amount of the soybean powder was constant was as follows. Specifically, there was a tendency that when the edible fat or oil content was changed from 3% by mass to 15% by mass, the appearance of the gelatinous food became less similar to that of crème caramel both between the examples and between the comparative examples.

### Production of Gelatinous Foods

### Example 3 and Comparative Example 3

Accordingly, Comparative Examples 1 and 2 showed that, regarding the type of edible fat or oil used in the gelatinous food comprising soybean powder, MCT1 is better than canola oil. Next, investigation was conducted for the upper limit of the content of the edible fat or oil (the triglyceride with the medium-chain fatty acids) in a gelatinous food comprising soybean powder.

In Example 3 and Comparative Example 3, examination was conducted, in view of an object of the present invention, for the acceptable upper limit of the amount of the edible fat or oil (the triglyceride with the medium-chain fatty acids) contained in a gelatinous food with the amount of the soybean powder being kept constant.

In Example 3 and Comparative Example 3, crème caramel-like foods which were gelatinous food not comprising any allergenic materials originated from egg, milk, wheat, buckwheat, peanut, shrimp/prawn/lobster, or crab were produced according to the formulae shown in Table 5 by the same method as in <Production of gelatinous foods> described above.

TABLE 5
Formulae of gelatinous foods (% by mass)

| | | Comp. |
|---|---|---|
| | Example 3 | Ex. 3 |
| Soybean powder | 12.00% | 12.00% |
| Canola oil | — | — |
| MCT1 | 40.00% | 45.00% |
| Custard flavor | 0.13% | 0.13% |
| Salt | 0.13% | 0.13% |
| Sugar | 8.13% | 8.13% |
| Agar | 0.12% | 0.12% |
| κ Carrageenan | 0.07% | 0.07% |
| Locust bean gum | 0.05% | 0.05% |
| Guar gum | 0.03% | 0.03% |
| Xanthan gum | 0.01% | 0.01% |
| Hot water at 98° C. | 39.33% | 34.33% |
| Total | 100.00% | 100.00% |

Also in Example 3 and Comparative Example 3, the same sensory evaluation as in <Method for Evaluating Gelatinous Foods> described above was conducted.

TABLE 6
Evaluation results

| | | Comp. |
|---|---|---|
| | Example 3 | Ex. 3 |
| Appearance | 3.0 | 2.1 |
| Soybean flavor | 4.7 | 4.8 |
| Richness | 4.9 | 4.9 |
| Smoothness | 4.3 | 4.2 |
| Oily feeling | 2.0 | 1.9 |
| Overall evaluation | 3.6 | 3.2 |

As can be seen from the results shown in Table 6, there was a tendency that the richness and the smoothness were increased, while the soybean flavor was reduced in Example 3 and Comparative Example 3 in comparison with Examples 1 and 2, where the MCT1 contents in the gelatinous foods were 3% and 15%, respectively. However, Example 3 and Comparative Example 3 were inferior to Examples 1 and 2 in terms of the oily feeling. In contrast to Example 3, the appearance of Comparative Example 3 was completely different from that of creme caramel. This was because MCT1 was separated in the gelatinous food. On the other hand, the appearance and the other evaluation items were not bad in Example 3, and the gelatinous food of Example 3 was acceptable with an overall evaluation score of 3.5 or higher. Accordingly, an suitable upper limit of the content of the edible fat or oil (the triglyceride with medium-chain fatty acids) was determined to be 40% by mass.

### [2] Liquid Foods

<Fat or Oil Ingredients>

[Soybean Powder]: Soybean powder (manufactured by The Nisshin OilliO Group, Ltd. under the trade name of Alphaplus HS-600) prepared by removing the seed coats of soybeans and then finely crushing and drying the soybeans was used as the soybean powder.
[MCT1]: A triglyceride with a medium-chain fatty acid(s) used as an edible fat or oil was MCT1 which was a triglyceride with medium-chain fatty acids (manufactured by The Nisshin OilliO Group, Ltd. under the trade name of MCT-C10R). In the triglyceride, the fatty acids constituting the triglyceride were n-octanoic acid (having 8 carbon atoms) and n-decanoic acid (having 10 carbon atoms), and the ratio (mass ratio) of the fatty acids constituting the triglyceride was as follows: n-octanoic acid:n-decanoic acid=30:70.
[MCT2]: Another triglyceride with a medium-chain fatty acid(s) used as an edible fat or oil was MCT2 which was a triglyceride with medium-chain fatty acids (manufactured by The Nisshin OilliO Group, Ltd. under the trade name of O.D.O). In the triglyceride, the fatty acids constituting the triglyceride were octanoic acid (having 8 carbon atoms) and decanoic acid (having 10 carbon atoms), and the ratio (mass ratio) of the fatty acids constituting the triglyceride was as follows: octanoic acid:decanoic acid=75:25.
[Rice Bran Oil]: Rice bran oil used was one manufactured by The Nisshin OilliO Group, Ltd. under the trade name of Nisshin Oishii Rice Oil. In the rice bran oil, the fatty acids constituting the triglyceride were palmitic acid (having 16 carbon atoms), oleic acid (having 18 carbon atoms), linoleic acid (having 18 carbon atoms), and others, and the ratio (mass ratio) of the fatty acids constituting the triglyceride was as follows: palmitic acid:oleic acid:linoleic acid:others=approximately 17:42:36:5. The content of triglycerides with a medium-chain fatty acid(s) in the rice bran oil was 0% by mass. [Canola Oil]: Canola oil used was one manufactured by The Nisshin OilliO Group, Ltd. under the trade name of Nisshin Canola Oil. In the canola oil, the fatty acids constituting the triglyceride were palmitic acid (having 16 carbon atoms), oleic acid (having 18 carbon atoms), linoleic acid (having 18 carbon atoms), and others, and the ratio (mass ratio) of the fatty acids constituting the triglyceride was as follows: palmitic acid:oleic acid:linoleic acid:others=approximately 4:61:20:15. The content of triglycerides having a medium-chain fatty acid(s) in the canola oil was 0% by mass.

Commercially available products were used as the other ingredients including a sweetener (sucrose), starch, salt, and a thickener (xanthan gum).

### Production of Liquid Foods

### Example 4 and Comparative Example 4

In Example 4 and Comparative Example 4, soups were produced which were liquid foods comprising soybean powder and an edible fat or oil in view of an object of the present invention. Moreover, to clarify the effect of the triglycerides with medium-chain fatty acids, the same experiment was conducted by using the canola oil as a comparative example.

More specifically, aliquots of MCT1 and the canola oil were poured, respectively, in Example 4 and Comparative Example 4 into 200 mL beakers in amounts of 0% by mass, 5% by mass, 10% by mass, 15% by mass, and 20% by mass relative to the total mass of the soup base composition shown in Table 7. To each of the 200 mL beakers, the soup base composition of Table 7 was added at a ratio of 10% by mass relative to the total mass of the finally obtained soup, and further boiling water was poured until the total amount reached 100 g. This solution was stirred thoroughly to produce a soup (soybean powder content: 60).

TABLE 7
Constitution of soup base composition (% by mass)

| | |
|---|---|
| Soybean powder | 60 |
| Sucrose | 20 |
| Starch | 16.3 |
| Common salt | 3.5 |
| Xanthan gum | 0.2 |
| Total | 100 |

<Method for Evaluating Soups>

The tastes of the thus produced soups were evaluated by ten well-experienced panelists. Specifically, the soups were evaluated in terms of five items, i.e., beany flavor, grassy flavor, astringency, oily feeling, and overall evaluation based on the following evaluation criteria (scored to one decimal place). The average value of the evaluation scores given by the ten panelists was obtained for each of the evaluation items. The obtained evaluation scores were rounded to one decimal place. Tables 8 and 9 show the taste evaluation results.

The beany flavor, the grassy flavor, the astringency, and the oily feeling were scored by a 3-point method.

3.0 points: Completely imperceptible

2.0 points: Slightly perceptible

1.0 points: Clearly perceptible

The overall evaluation was scored by a 5-point method.

5.0 points: Taste good with good flavor

4.0 points: Taste good despite slight lack of good flavor

3.0 points: Suitable as commercial product despite lack of good flavor

2.0 points: Unsuitable as commercial product because of the presence of unpleasant flavor

1.0 points: Undrinkable because of strong unpleasant flavor

TABLE 8
Evaluation results of MCT1-containing soups (Example 4)

| Added | Overall | Beany | Grassy | | Oily |
|---|---|---|---|---|---|
| amount (%) | evaluation | flavor | flavor | Astringency | feeling |
| 5 | 2.3 | 1.5 | 2.1 | 2.1 | 2.6 |
| 10 | 4.1 | 2.5 | 2.5 | 2.3 | 2.3 |
| 15 | 4.0 | 2.7 | 2.7 | 2.5 | 2.2 |
| 20 | 3.9 | 2.7 | 2.7 | 2.5 | 1.9 |
| 0 | 2.1 | 1.3 | 1.2 | 1.2 | 2.7 |
| (control) | | | | | |

TABLE 9
Evaluation results of canola oil-containing
soups (Comparative Example 4)

| Added | Overall | Beany | Grassy | | Oily |
|---|---|---|---|---|---|
| amount (%) | evaluation | flavor | flavor | Astringency | feeling |
| 5 | 2.0 | 1.4 | 2.0 | 1.9 | 2.2 |
| 10 | 2.3 | 1.7 | 2.1 | 1.9 | 1.8 |
| 15 | 2.3 | 1.8 | 2.1 | 2.0 | 1.4 |
| 20 | 2.2 | 2.1 | 2 | 2.1 | 1.3 |
| 0 | 2.1 | 1.3 | 1.2 | 1.2 | 2.7 |
| (control) | | | | | |

As can be seen from the results shown in Tables 8 and 9 above, the beany flavor, grassy flavor, and astringency, which were characteristic of soybeans, of the soups comprising soybean powder and an edible fat or oil were more reduced in the soups of Example 4 than in those of Comparative Example 4. In addition, the soups of Example 4 to which MCT1 was added had less oily feeling than the soups of Comparative Example 4 to which the canola oil was added. These results have shown that, regarding the type of an edible fat or oil which can be added to a soup comprising soybean powder and the edible fat or oil, a triglyceride with a medium-chain fatty acid(s) is more suitable than canola oil.

### Production of Liquid Foods

### Examples 5 and 6

In Examples 5 and 6, soybean beverages which were liquid foods comprising soybean powder and an edible fat or oil were produced instead of soups in a usual manner in view of an object of the present invention.

More specifically, the temperature of water was adjusted to 80° C., and 100 g of the soybean powder was mixed with MCT1 or MCT2 in amounts of 0% by mass, 5% by mass, 10% by mass, 15% by mass, and 20% by mass relative to the total mass of the water and the soybean powder. Moreover, the total amount of each of the solutions was adjusted to 1000 ml by using water at 80° C. Each of the solutions was mixed with thorough stirring and held at 80° C. for 20 minutes. Thus, soybean powder beverages for test were produced (soybean powder content: 10%).

<Method for Evaluating Soybean Beverages>

Also in Examples 5 and 6, the same sensory evaluation as in <Method for Evaluating Soups> described above was conducted.

TABLE 10
Evaluation results of MCT1-containing
soybean beverages (Example 5)

| Added | Overall | Beany | Grassy | | Oily |
|---|---|---|---|---|---|
| amount (%) | evaluation | flavor | flavor | Astringency | feeling |
| 5 | 3.4 | 1.8 | 2.1 | 2.1 | 2.7 |
| 10 | 3.5 | 2.2 | 2.4 | 2.3 | 2.4 |
| 15 | 3.5 | 2.4 | 2.5 | 2.4 | 1.7 |
| 20 | 3.1 | 2.5 | 2.6 | 2.4 | 1.4 |
| 0 | 2.0 | 1.2 | 1.2 | 1.2 | 2.7 |
| (control) | | | | | |

TABLE 11
Evaluation results of MCT2-containing
soybean beverages (Example 6)

| Added | Overall | Beany | Grassy | | Oily |
|---|---|---|---|---|---|
| amount (%) | evaluation | flavor | flavor | Astringency | feeling |
| 5 | 3.7 | 2.3 | 2.3 | 2.1 | 2.6 |
| 10 | 3.7 | 2.4 | 2.7 | 2.3 | 2.2 |
| 15 | 3.6 | 2.4 | 2.7 | 2.4 | 1.7 |
| 20 | 2.9 | 2.6 | 2.7 | 2.5 | 1.3 |
| 0 | 2.0 | 1.2 | 1.2 | 1.2 | 2.7 |
| (control) | | | | | |

As can be seen from the results shown in Tables 10 and 11 above, the beany flavor, grassy flavor, and astringency, which were characteristic of soybeans, were reduced in the soybean beverages to which the soybean powder and the triglyceride with medium-chain fatty acids were add, when either MCT1 or MCT2 was add as the triglyceride. Since no significant difference in effect was found between MCT1 and MCT2 as described above, it has been found that no great difference in effect is present between the medium-chain fatty acid having 8 carbon atoms and the medium-chain fatty acid having 10 carbon atoms.

### Production of Liquid Foods

### Comparative Examples 5 and 6

In Comparative Examples 5 and 6, soybean beverages which were liquid foods comprising the soybean powder and an edible fat or oil were produced in a usual manner by using the rice bran oil or the canola oil instead of the triglyceride with medium-chain fatty acids in view of an object of the present invention.

More specifically, the temperature of water was adjusted to 80° C., and 100 g of the soybean powder was mixed with the rice bran oil or the canola oil in amounts of 0% by mass, 5% by mass, 10% by mass, 15% by mass, and 20% by mass relative to the total mass of the water and the soybean powder. Moreover, the total amount of each of the solutions was adjusted to 1000 ml by using water at 80° C. Each of the solutions was mixed with thorough stirring and held at 80° C. for 20 minutes. Thus, soybean powder beverages for test were produced (soybean powder content: 10%).

### [Sensory Evaluation]

Also in Comparative Examples 5 and 6, the same sensory evaluation as in <Method for Evaluating Soups> described above was conducted.

TABLE 12
Evaluation results of rice bran oil-containing
soybean beverages (Comparative Example 5)

| Added | Overall | Beany | Grassy | | Oily |
|---|---|---|---|---|---|
| amount (%) | evaluation | flavor | flavor | Astringency | feeling |
| 5 | 2.8 | 1.6 | 1.8 | 1.6 | 2.4 |
| 10 | 2.8 | 1.9 | 2.1 | 1.8 | 1.8 |
| 15 | 2.8 | 1.9 | 2.4 | 2.1 | 1.4 |
| 20 | 2.7 | 2.1 | 2.4 | 2.2 | 1.2 |
| 0 | 2.0 | 1.2 | 1.2 | 1.2 | 2.8 |
| (control) | | | | | |

TABLE 13
Evaluation results of canola oil-containing
soybean beverages (Comparative Example 6)

| Added | Overall | Beany | Grassy | | Oily |
|---|---|---|---|---|---|
| amount (%) | evaluation | flavor | flavor | Astringency | feeling |
| 5 | 2.5 | 1.7 | 1.8 | 1.8 | 2.4 |
| 10 | 2.7 | 2.0 | 2.2 | 2.1 | 1.9 |
| 15 | 2.6 | 1.9 | 2.1 | 2.0 | 1.4 |
| 20 | 2.4 | 1.9 | 2.2 | 1.9 | 1.2 |
| 0 | 2.0 | 1.2 | 1.2 | 1.2 | 2.8 |
| (control) | | | | | |

As can be seen from the results shown in Tables 12 and 13 above, the beany flavor and grassy flavor, which were characteristic of soybeans, were reduced to some degrees, but the astringency was not reduced so much in the soybean beverages comprising the soybean powder and the edible fat or oil (the rice bran oil or the canola oil).

### [3] Cold Sweets

<Ingredients>

The soybean powder used was one manufactured by The Nisshin OilliO Group, Ltd. under the trade name of “Alphaplus HS-600” (average particle diameter: 30 μm).

The triglyceride with medium-chain fatty acids used was a triglyceride with medium-chain fatty acids manufactured by The Nisshin OilliO Group, Ltd. under the trade name of MCT-C10R (hereinafter, also referred to as MCT1). In the triglyceride, the fatty acids constituting the triglyceride were n-octanoic acid (having 8 carbon atoms) and n-decanoic acid (having 10 carbon atoms), and the ratio (mass ratio) of the fatty acids constituting the triglyceride was as follows: n-octanoic acid:n-decanoic acid=30:70.

Others used were the above-described canola oil (manufactured by The Nisshin OilliO Group, Ltd. under the trade name of Nisshin Canola Oil with a content of triglycerides with a medium-chain fatty acid(s) being 0% by mass), and a hydrogenated coconut oil (manufactured by The Nisshin OilliO Group, Ltd. under the trade name of Yashi Koka Yu 34 (hydrogenated coconut oil 34) with a content of triglycerides with a medium-chain fatty acid(s) being 53.2% by mass).

Commercially available products were used as an emulsifier, starch syrup, granulated sugar, and the like.

<Production I of Ice Cream-Like Foods (Examination of Edible Fat or Oil Composition)>

Ice cream-like foods of Example 7 and Comparative Examples 7 and 8 were produced according to the formulae in Table 14. Specifically, an oil phase and a water phase were each melted by heating, and the oil phase was mixed into the water phase with stirring. Thus, preliminary emulsification and thermal sterilization at 80° C. were performed. Moreover, the mixture was homogenized with a high-pressure homogenizer at 11 MPa, and then cooled and aged to obtain a liquid mix. The mix was refrigerated in an ice-cream maker, while air was being introduced into the mix, and solidified by freezing (at −30° C.) to obtain each ice cream-like food.

TABLE 14
Formulae I of ice cream-like foods (Unit: % by mass)

| | | | Comp. | Comp. |
|---|---|---|---|---|
| | | Ex. 7 | Ex. 7 | Ex. 8 |
| Oil | MCT1 | 15 | — | — |
| phase | Canola oil | — | 15 | 5 |
| | Hydrogenated coconut oil | — | — | 10 |
| | Emulsifier | 1 | 1 | 1 |
| Water | Water | 60 | 60 | 60 |
| phase | Soybean powder | 10 | 10 | 10 |
| | Starch syrup | 7 | 7 | 7 |
| | Granulated sugar | 7 | 7 | 7 |

| | | | |
|---|---|---|---|
| Total | 100 | 100 | 100 |
| MTG (medium-chain fatty acid | 100 | 0 | 35.5 |
| triglyceride) content in edible | | | |
| fat or oil | | | |

*In the table above, MTG means all triglycerides with a medium-chain fatty acid(s) having 6 to 12 carbon atoms, including medium-chain fatty acid triglycerides other than MCT1. Hereinafter, the definition of MTG is the same. Note that MCT means triglycerides containing only the above-described medium-chain fatty acids.

<Evaluation I of Ice Cream-Like Foods>

The tastes of the thus produced ice cream-like foods of Example 7 and Comparative Examples 7 and 8 were evaluated by nine well-experienced panelists. Specifically, the ice cream-like foods were evaluated in terms of six items, i.e., feel-on-the-tongue, melt-in-the-mouth, richness, milkiness, oily feeling, and soybean flavor (grassy flavor and astringency) by using the following evaluation criteria, and the average value of the evaluation scores given by the nine panelists was obtained for each evaluation item. Each evaluation score was rounded to one decimal place. In addition, an average value of these average values for the six items was employed as the overall evaluation. When the average values of all the evaluation items were 2.5 or higher, and the overall evaluation was 3.0 or higher, the cream-like food was determined to be acceptable. Table 15 shows the evaluation results.

### Method for Scoring Feel-on-the-Tongue

5 points: Very good

4 points: Good

3 points: Fair

2 points: Graininess was slightly perceptible

1 point: Graininess was perceptible

### Method for Scoring Melt-in-the-Mouth

5 points: Very good

4 points: Good

3 points: Fair

2 points: Slightly slow

1 point: Poor in melt-in-the-mouth

### Method for Scoring Richness

5 points: Clearly perceptible

4 points: Perceptible

3 points: Slightly perceptible

2 points: Almost imperceptible

1 point: Completely imperceptible

### Method for Scoring Milkiness

5 points: Clearly perceptible

4 points: Perceptible

3 points: Slightly perceptible

2 points: Almost imperceptible

1 point: Completely imperceptible

### Method for Scoring Oily Feeling

5 points: Completely imperceptible

4 points: Almost imperceptible

3 points: Slightly perceptible

2 points: Perceptible

1 point: Clearly perceptible

### Method for Scoring Soybean Flavor

5 points: Completely imperceptible

4 points: Almost imperceptible

3 points: Slightly perceptible

2 points: Perceptible

1 point: Clearly perceptible

TABLE 15
Evaluation results I

| | | Comp. | Comp. |
|---|---|---|---|
| | Ex. 7 | Ex. 7 | Ex. 8 |
| Feel-on-the-tongue | 4.2 | 3.4 | 3.6 |
| Melt-in-the-mouth | 4.0 | 3.1 | 3.4 |
| Richness | 4.4 | 3.1 | 3.4 |
| Milkiness | 4.1 | 2.7 | 2.7 |
| Oily feeling | 3.8 | 2.3 | 2.3 |
| Soybean flavor | 3.4 | 2.4 | 2.2 |
| Overall evaluation | 4.0 | 2.9 | 2.9 |

<Production II of Ice Cream-Like Foods (Examination of Soybean Powder Content)>

Ice cream-like foods of Examples 8 and 9 and Comparative Examples 9 and 10 were produced in the same manner as in <Production I of Ice Cream-like Foods> according to the formulae in Table 16.

TABLE 16
Formulae II of ice cream-like foods (Unit: % by mass)

| | | Comp. | | | Comp. |
|---|---|---|---|---|---|
| | | Ex. 9 | Ex. 8 | Ex. 9 | Ex. 10 |
| Oil | MCT1 | 15 | 15 | 15 | 15 |
| phase | Canola oil | — | — | — | — |
| | Hydrogenated | — | — | — | — |
| | coconut oil | | | | |
| | Emulsifier | 1 | 1 | 1 | 1 |
| Water | Water | 70 | 69.5 | 55 | 52 |
| phase | Soybean powder | — | 0.5 | 15 | 18 |
| | Starch syrup | 7 | 7 | 7 | 7 |
| | Granulated | 7 | 7 | 7 | 7 |
| | sugar | | | | |

| | | | | |
|---|---|---|---|---|
| Total | 100 | 100 | 100 | 100 |
| MTG (medium-chain fatty | 100 | 100 | 100 | 100 |
| acid triglyceride) | | | | |
| content in edible fat or oil | | | | |

<Evaluation II of Ice Cream-Like Foods>

The tastes of the ice cream-like foods of Examples 8 and 9 and Comparative Examples 9 and 10 were evaluated in the same manner as in <Evaluation I of Ice Cream-like Foods>. Table 17 shows the evaluation results.

TABLE 17
Evaluation results II

| | Comp. | | | Comp. |
|---|---|---|---|---|
| | Ex. 9 | Ex. 8 | Ex. 9 | Ex. 10 |
| Feel-on-the-tongue | 2.6 | 3.2 | 3.9 | 2.9 |
| Melt-in-the-mouth | 2.8 | 3.7 | 3.9 | 2.5 |
| Richness | 1.1 | 2.7 | 4.3 | 4.5 |
| Milkiness | 1.4 | 2.8 | 3.7 | 3.2 |
| Oily feeling | 3.1 | 3.4 | 3.6 | 3.3 |
| Soybean flavor | 4.9 | 4.7 | 2.6 | 1.2 |
| Overall evaluation | 2.7 | 3.4 | 3.7 | 2.9 |

<Production III of Ice Cream-Like Foods (Examination of Edible Fat or Oil Content)>

Ice cream-like foods of Examples 10 and 11 and Comparative Examples 11 and 12 were produced in the same manner as in <Production I of Ice Cream-like Foods> according to the formulae in Table 18.

TABLE 18
Formulae III of ice cream-like foods (Unit: % by mass)

| | | Comp. | | | Comp. |
|---|---|---|---|---|---|
| | | Ex. 11 | Ex. 10 | Ex. 11 | Ex. 12 |
| Oil | MCT1 | — | 1 | 20 | 30 |
| phase | Canola oil | — | — | — | — |
| | Hydrogenated | — | — | — | — |
| | coconut oil | | | | |
| | Emulsifier | 1 | 1 | 1 | 1 |
| Water | Water | 75 | 74 | 55 | 45 |
| phase | Soybean powder | 10 | 10 | 10 | 10 |
| | Starch syrup | 7 | 7 | 7 | 7 |
| | Granulated | 7 | 7 | 7 | 7 |
| | sugar | | | | |

| | | | | |
|---|---|---|---|---|
| Total | 100 | 100 | 100 | 100 |
| MTG (medium-chain fatty | 100 | 100 | 100 | 100 |
| acid triglyceride) | | | | |
| content in edible fat or oil | | | | |

<Evaluation III of Ice Cream-Like Foods>

The tastes of the ice cream-like foods of Examples 10 and 11 and Comparative Examples 11 and 12 were evaluated in the same manner as in <Evaluation I of Ice Cream-like Foods>. Table 19 shows the evaluation results.

TABLE 19
Evaluation results III

| | Comp. | | | Comp. |
|---|---|---|---|---|
| | Ex. 11 | Ex. 10 | Ex. 11 | Ex. 12 |
| Feel-on-the-tongue | 2.6 | 3.3 | 4.3 | 3.4 |
| Melt-in-the-mouth | 2.6 | 3.6 | 4.3 | 2.8 |
| Richness | 2.0 | 3.0 | 4.5 | 3.8 |
| Milkiness | 1.9 | 3.1 | 4.5 | 4.0 |
| Oily feeling | 3.9 | 4.0 | 3.5 | 1.4 |
| Soybean flavor | 1.6 | 3.1 | 3.4 | 3.5 |
| Overall evaluation | 2.4 | 3.3 | 4.1 | 3.2 |

### [4] Soft Candies

<Ingredients>

Soybean powder used was a full-fat soybean powder manufactured by The Nisshin OilliO Group, Ltd. under the trade name of Alphaplus HS-600.

A triglyceride with a medium-chain fatty acid(s) used as an edible fat or oil was one manufactured by The Nisshin OilliO Group, Ltd. under the trade name of MCT-C10R (hereinafter, also referred to as MCT1). In the triglyceride, the fatty acids constituting the triglyceride were n-octanoic acid (having 8 carbon atoms) and n-decanoic acid (having 10 carbon atoms), and the ratio (mass ratio) of the fatty acids constituting the triglyceride was as follows: n-octanoic acid:n-decanoic acid=30:70.

A hydrogenated oil used as another edible fat or oil was one manufactured by The Nisshin OilliO Group, Ltd., which was a fat or oil obtained by mixing 98% by mass of palm kernel oil and 2% by mass of palm oil with each other and then extremely hardening the mixture, and which had a melting point of 42° C., did not contain any trans fatty acids, and contained 43.8% by mass of lauric acid. The content of triglycerides with a medium-chain fatty acid(s) in the hydrogenated oil was 22.2% by mass.

A canola oil used as still another edible fat or oil was one manufactured by The Nisshin OilliO Group, Ltd. under the trade name of Nisshin Canola Oil. In the canola oil, the fatty acids constituting the triglyceride were palmitic acid (having 16 carbon atoms), oleic acid (having 18 carbon atoms), linoleic acid (having 18 carbon atoms), and others, and the ratio (mass ratio) of the fatty acids constituting the triglyceride was as follows: palmitic acid:oleic acid:linoleic acid:others=approximately 4:61:20:15. The content of triglycerides with a medium-chain fatty acid(s) in the canola oil was 0% by mass.

Commercially available products were used as other ingredients including starch syrup, a thickener (gelatin), and sugar fondant.

### Production of Soft Candies

### Example 13 and Comparative Examples 13 and 14

In Example 12 and Comparative Examples 13 and 14, soft candies were produced in a usual manner according to the formulae shown in Table 20. More specifically, a first material was prepared by boiling down starch syrup and table sugar at 100° C. A second material was prepared according to the corresponding one of the formulae by heating the edible fat or oil to 80° C., then adding the soybean powder thereto, and then boiling down the mixture at 90° C. The first material and the second material were mixed with each other. Then, while this mixture was held at 75° C., a third material including gelatin, sugar fondant, and water was added, and further the mixture was boiled down. Thus, each soft candy was obtained.

TABLE 20
Formulae of soft candies

| | | | Comp. | Comp. |
|---|---|---|---|---|
| | Ingredient name | Ex. 12 | Ex. 13 | Ex. 14 |
| First | Starch syrup | 35.60% | 35.60% | 35.60% |
| material | Sugar | 11.90% | 11.90% | 11.90% |
| Second | MCT1 | 19.80% | — | — |
| material | Hydrogenated oil | — | 19.80% | — |
| | Canola oil | — | — | 19.80% |
| | Soybean powder | 13.90% | 13.90% | 13.90% |
| | Water | 1.80% | 1.80% | 1.80% |
| Third | Gelatin | 1.20% | 1.20% | 1.20% |
| material | Sugar fondant | 11.90% | 11.90% | 11.90% |
| | Water | 4.00% | 4.00% | 4.00% |
| | Total | 100.00% | 100.00% | 100.00% |

<Method for Evaluating Soft Candies>

The tastes of the thus produced soft candies of Example 12 and Comparative Examples 13 and 14 were evaluated by nine well-experienced panelists. Specifically, the soft candies were evaluated in terms of six items, namely, feel-on-the-tongue, mouthfeel, melt-in-the-mouth, oily feeling, oily odor, and soybean flavor based on the evaluation criteria in Table 21 (scored to one decimal place). Then, the average value of the evaluation scores given by the nine panelists was obtained for each evaluation item. Each evaluation score was rounded to one decimal place. When the average values of the evaluation items were all 3.5 or higher, the soft candy was determined to be acceptable. Table 22 shows the taste evaluation results.

TABLE 21
Criteria of taste evaluation

| Evaluation score | Evaluation content |
|---|---|
| 5.0 points | Very good |
| 4.0 points | Good |
| 3.0 points | Intermediate |
| 2.0 points | Poor |
| 1.0 points | Very poor |

TABLE 22
Evaluation results

| | | Comp. | Comp. |
|---|---|---|---|
| | Ex. 12 | Ex. 13 | Ex. 14 |
| Feel-on-the-tongue | 4.4 | 3.5 | 3.5 |
| Mouthfeel | 4.5 | 3.4 | 3.1 |
| Melt-in-the-mouth | 4.2 | 3.2 | 3.1 |
| Oily feeling | 4.1 | 3.3 | 2.7 |
| Oily odor | 4.0 | 2.8 | 2.1 |
| Soybean flavor | 4.2 | 2.4 | 3.1 |
| Average value | 4.2 | 3.1 | 2.9 |

As can be seen from the results shown in Table 22, the scores of all the taste evaluation items of the soft candy of Example 12 using MCT1 were 3.5 or higher, and hence the soft candy of Example 12 was acceptable. The soft candies of Comparative Examples 13 and 14 in which an edible fat or oil which was not a triglyceride with a medium-chain fatty acid(s), such as the hydrogenated oil or the canola oil, was used instead of MCT1 with the contents of the soybean powder, the table sugar, the starch syrup, the gelatin, the sugar fondant, and the water being the same values were acceptable in terms of the feel-on-the-tongue because of the addition of the edible fat or oil, but were inferior to that using the triglyceride with medium-chain fatty acids in terms of the other taste evaluation items.

Comparative Examples 13 and 14 demonstrates that a triglyceride with medium-chain fatty acids is better as an edible fat or oil used for soft candies comprising soybean powder. Next, the contents of the soybean powder and the triglyceride with medium-chain fatty acids in a soft candy were examined.

### Production of Soft Candies

### Examples 13 and 14 and Comparative Examples 15 and 16

In Examples 13 and 14 and Comparative Examples 15 and 16, soft candies were produced according to the formulae shown in Table 23.

Example 13 and Comparative Example 15 were carried out in view of an object of the present invention to determine the upper limit of the content of the triglyceride with the medium-chain fatty acids incorporated in a soft candy. The amount of the edible fat or oil (the triglyceride with the medium-chain fatty acids) was changed by adjusting the amounts of the starch syrup and the like incorporated.

Example 14 and Comparative Example 16 were carried out in view of an object of the present invention to determine the upper limit of the content of the soybean powder incorporated in a soft candy. The amount of the soybean powder was changed by adjusting the amounts of starch syrup and the like incorporated.

In Examples 13 and 14 and Comparative Examples 15 and 16, soft candies were produced in a usual manner according to the formulae shown in Table 23. More specifically, a first material was prepared by boiling down starch syrup and table sugar at 100° C. A second material was prepared by heating the edible fat or oil to 80° C., then adding the soybean powder thereto, and boiling down the mixture at 90° C. The first material and the second material were mixed with each other. Then, this mixture was held at 75° C., and a third material, including gelatin, sugar fondant, and water, was added thereto, and further the mixture was boiled down. Thus, each soft candy was obtained.

TABLE 23
Formulae of soft candies

| | Ingredient | | Comp. | | Comp. |
|---|---|---|---|---|---|
| | name | Ex. 13 | Ex. 15 | Ex. 14 | Ex. 16 |
| First | Starch syrup | 32.40% | 29.20% | 51.80% | 50.70% |
| material | Sugar | 10.80% | 9.70% | — | — |
| Second | MCT1 | 34.20% | 40.50% | 5.20% | 5.10% |
| material | Soybean | 5.40% | 5.20% | 30.20% | 35.90% |
| | powder | | | | |
| | Water | 1.60% | 1.50% | 1.90% | 1.90% |
| Third | Gelatin | 1.10% | 1.00% | 1.30% | 1.30% |
| material | Sugar fondant | 10.80% | 9.70% | 4.30% | — |
| | Water | 3.60% | 3.20% | 5.20% | 5.10% |
| | Total | 100.00% | 100.00% | 100.00% | 100.00% |

The tastes of the thus produced soft candies of Examples 13 and 14 and Comparative Examples 15 and 16 were evaluated by nine well-experienced panelists. Specifically, the soft candies were evaluated in terms of six items, namely, feel-on-the-tongue, mouthfeel, melt-in-the-mouth, oily feeling, oily odor, and soybean flavor based on the evaluation criteria in Table 24 (scored to one decimal place). Then, the average value of the evaluation scores given by the nine panelists was obtained for each evaluation item. The evaluation scores were rounded to one decimal place. When the average values of the evaluation items were all 3.5 or higher, the soft candy was determined to be acceptable. Table 25 shows the taste evaluation results.

TABLE 24
Criteria of taste evaluation

| Evaluation score | Evaluation content |
|---|---|
| 5.0 points | Very good |
| 4.0 points | Good |
| 3.0 points | Intermediate |
| 2.0 points | Poor |
| 1.0 points | Very poor |

TABLE 25
Evaluation results

| | | Comp. | | Comp. |
|---|---|---|---|---|
| | Ex. 13 | Ex. 15 | Ex. 14 | Ex. 16 |
| Feel-on-the-tongue | 3.9 | 3.3 | 3.1 | 2.0 |
| Mouthfeel | 3.6 | 2.0 | 3.2 | 2.0 |
| Melt-in-the-mouth | 3.8 | 3.7 | 2.8 | 2.1 |
| Oily feeling | 3.0 | 1.3 | 4.5 | 4.3 |
| Oily odor | 3.1 | 2.0 | 4.4 | 4.2 |
| Soybean flavor | 4.5 | 4.2 | 2.8 | 1.9 |
| Average value | 3.7 | 2.8 | 3.5 | 2.8 |

As can be seen from the results shown in Table 25, the melt-in-the-mouth was good, and the soybean flavor was well reduced in each of Example 13 and Comparative Example 15, where MCT1 was incorporated at 34.2% by mass and 40.5% by mass, respectively. However, in Comparative Example 15, the oily feeling, the oily odor, and the like affected the flavor and mouthfeel. Hence, the average value of the other evaluation items indicated that the soft candy of Comparative Example 15 was unacceptable. Accordingly, the upper limit of the content of the edible fat or oil was determined to be 40% by mass.

In addition, in Example 14 and Comparative Example 16, where the soybean powder was incorporated at 30.2% by mass and 35.9% by mass, respectively, the candies were excellent in terms of oily feeling and oily odor. However, there was a tendency that the taste becomes poorer in terms of feel-on-the-tongue, mouthfeel, melt-in-the-mouth, and soybean flavor with the increase in amount of the soybean powder relative to the soft candy. As a result, the average value of the evaluation items indicated that the soft candy of Comparative Example 16 was unacceptable. Accordingly, the upper limit of the content of the soybean powder was determined to be 35% by mass.

### [5] Cheese-Like Foods

<Ingredients>

The soybean powder used was one manufactured by The Nisshin OilliO Group, Ltd. under the trade name of “Alphaplus HS-600.”

An edible fat or oil (medium-chain fatty acid triglyceride) used was a triglyceride with medium-chain fatty acids manufactured by The Nisshin OilliO Group, Ltd. under the trade name of MCT-C10R (hereinafter, also referred to as MCT1). In the triglyceride, the fatty acids constituting the triglyceride were n-octanoic acid (having 8 carbon atoms) and n-decanoic acid (having 10 carbon atoms), and the ratio (mass ratio) of the fatty acids constituting the triglyceride was as follows: n-octanoic acid:n-decanoic acid=30:70.

Another edible fat or oil (canola oil) used was canola oil manufactured by The Nisshin OilliO Group, Ltd. under the trade name of Nisshin Canola Oil. In the canola oil, the fatty acids constituting the triglyceride were palmitic acid (having 16 carbon atoms), oleic acid (having 18 carbon atoms), linoleic acid (having 18 carbon atoms), and others, and the ratio (mass ratio) of the fatty acids constituting the triglyceride was as follows: palmitic acid:oleic acid:linoleic acid:others=approximately 4:61:20:15.

Commercially available products were used as common salt, an organic acid (citric acid), agar, a thickener (pectin), and a cheese flavor (a flavor not containing any allergenic material originated from milk). Note that the content of triglycerides with a medium-chain fatty acid(s) in the canola oil was 0% by mass.

### Production of Cheese-Like Foods

### Examples 15 to 17 and Comparative Examples 17 to 23

Cheese-like foods not containing any allergenic materials originated from egg, milk, wheat, buckwheat, peanut, shrimp/prawn/lobster, or crab were produced according to the formulae shown in Tables 26 and 27.

Examples 15 to 17 and Comparative Examples 17 to 23 were carried out in view of an object of the present invention to determine the lower limit and the upper limit of the amount of each of soybean powder and an edible fat or oil which can be contained in a cheese-like food comprising the soybean powder and the edible fat or oil.

In this respect, the upper limit of the amount of the soybean powder added to a cheese-like food was as follows. When the soybean powder was dissolved in water, the viscosity of the cheese-like food increased with the increase in amount of the soybean powder. However, the workability was not impaired, when the amount of the soybean powder was 35% by mass or lower. This has shown that a suitable upper limit of the amount of the soybean powder added to a cheese-like food is 30% by mass.

In addition, since the amount of an edible fat or oil which can be added decreases with the increase in amount of soybean powder added, the amount of the soybean powder was changed by adjusting the amounts of the edible fat or oil and water incorporated.

Moreover, to clarify an effect of the triglyceride with medium-chain fatty acids, similar experiments were carried out as comparative examples by using the canola oil.

The production method was specifically as follows. Water and the soybean powder were mixed with each other in a mixing container at normal temperature, and then the edible fat or oil was added, followed by mixing. Then, common salt, citric acid, and the cheese flavor were added, followed by further mixing. After that, agar and pectin were added, followed by mixing. The obtained mixture was subjected to a heat treatment at 90° C. for minutes. Thus, each cheese-like food was obtained. Specific incorporated amounts in Examples 15 to 17 and Comparative Examples 17 to 23 are shown in Table 26 (cases where MCT1 was used) or Table 27 (cases where the canola oil was used).

TABLE 26
Formulae of cheese-like foods (Numeric values are expressed
in % by mass, except those marked with *2)

| | Comp. | | | | Comp. |
|---|---|---|---|---|---|
| | Ex. 17 | Ex. 15 | Ex. 16 | Ex. 17 | Ex. 18 |
| Soybean powder | 5 | 10 | 20 | 30 | 35 |
| MCT1 | 45 | 40 | 20 | 5 | 1 |
| Canola oil | — | — | — | — | — |
| Common salt | 1.5 | 1.5 | 1.5 | 1.5 | 1.5 |
| Citric acid | 0.5 | 0.5 | 0.5 | 0.5 | 0.5 |
| Agar | 0.5 | 0.5 | 0.5 | 0.5 | 0.5 |
| Pectin | 0.5 | 0.5 | 0.5 | 0.5 | 0.5 |
| Cheese flavor | 0.2 | 0.2 | 0.2 | 0.2 | 0.2 |
| Water | 46.8 | 46.8 | 56.8 | 61.8 | 60.8 |
| Total | 100 | 100 | 100 | 100 | 100 |
| MTG (medium-chain | 100 | 100 | 100 | 100 | 100 |
| fatty acid triglyceride) | | | | | |
| content *1 | | | | | |
| Mass ratio *2 | 1:9 | 1:4 | 1: 1 | 6:1 | 35:1 |

*1: MTG (medium-chain fatty acid triglyceride) content in edible fat or oil.
*2: Mass ratio between soybean powder and edible fat or oil.

TABLE 27
Formulae of cheese-like foods (Numeric values are expressed
in % by mass, except those marked with *2)

| | Comp. | Comp. | Comp. | Comp. | Comp. |
|---|---|---|---|---|---|
| | Ex. 19 | Ex. 20 | Ex. 21 | Ex. 22 | Ex. 23 |
| Soybean powder | 5 | 10 | 20 | 30 | 35 |
| MCT1 | — | — | — | — | — |
| Canola oil | 45 | 40 | 20 | 5 | 1 |
| Common salt | 1.5 | 1.5 | 1.5 | 1.5 | 1.5 |
| Citric acid | 0.5 | 0.5 | 0.5 | 0.5 | 0.5 |
| Agar | 0.5 | 0.5 | 0.5 | 0.5 | 0.5 |
| Pectin | 0.5 | 0.5 | 0.5 | 0.5 | 0.5 |
| Cheese flavor | 0.2 | 0.2 | 0.2 | 0.2 | 0.2 |
| Water | 46.8 | 46.8 | 56.8 | 61.8 | 60.8 |
| Total | 100 | 100 | 100 | 100 | 100 |
| MTG (medium-chain | 0 | 0 | 0 | 0 | 0 |
| fatty acid triglyceride) | | | | | |
| content *1 | | | | | |
| mass ratio *1 | 1:9 | 1:4 | 1:1 | 6:1 | 35:1 |

*1: MTG (medium-chain fatty acid triglyceride) content in edible fat or oil
*2: Mass ratio between soybean powder and edible fat or oil

<Evaluation of Appearance, Odor, and Taste of Cheese-Like Foods>

All the cheese-like foods produced in Examples 15 to 17 and Comparative Examples 17 to 23 had cheese-like appearance (color) and cheese-like odor.

In addition, the tastes of the produced cheese-like foods were evaluated by nine well-experienced panelists.

Specifically, the cheese-like foods were evaluated in terms of six items, namely, feel-on-the-tongue, mouthfeel, melt-in-the-mouth, richness, oiliness, and soybean flavor based on the evaluation criteria in Table 28 (scored to one decimal place). Then, the average value of the evaluation scores given by the nine panelists was obtained for each evaluation item. Further, the overall evaluation, which was the average value of the evaluation items, was calculated. When the overall evaluation was 3.5 or higher, the cheese-like food was determined to be acceptable. Tables 29 and 30 show the taste evaluation results.

TABLE 28
Criteria of taste evaluation

| Evaluation score | Evaluation content |
|---|---|
| 5.0 points | Very good |
| 4.0 points | Good |
| 3.0 points | Intermediate |
| 2.0 points | Poor |
| 1.0 points | Very poor |

TABLE 29
Taste evaluation results

| | Comp. | | | | Comp. |
|---|---|---|---|---|---|
| | Ex. 17 | Ex. 15 | Ex. 16 | Ex. 17 | Ex. 18 |
| Feel-on-the-tongue | 3.0 | 4.1 | 4.5 | 3.8 | 2.5 |
| Mouthfeel | 2.4 | 4.1 | 4.4 | 3.9 | 2.7 |
| Melt-in-the-mouth | 3.7 | 4.2 | 4.4 | 3.2 | 2.2 |
| Richness | 2.1 | 3.5 | 4.2 | 4.4 | 3.8 |
| Oiliness | 2.3 | 3.0 | 3.9 | 4.0 | 3.9 |
| Soybean flavor | 4.6 | 4.6 | 4.3 | 3.7 | 2.5 |
| Overall evaluation | 3.0 | 3.9 | 4.3 | 3.8 | 2.9 |

TABLE 30
Taste evaluation results

| | Comp. | Comp. | Comp. | Comp. | Comp. |
|---|---|---|---|---|---|
| | Ex. 19 | Ex. 20 | Ex. 21 | Ex. 22 | Ex. 23 |
| Feel-on-the-tongue | 3.0 | 3.2 | 3.5 | 3.3 | 2.0 |
| Mouthfeel | 2.1 | 2.9 | 3.5 | 3.0 | 2.4 |
| Melt-in-the-mouth | 3.3 | 3.5 | 3.4 | 2.5 | 1.8 |
| Richness | 1.5 | 2.5 | 3.2 | 3.6 | 3.6 |
| Oiliness | 1.6 | 1.8 | 2.8 | 3.3 | 3.8 |
| Soybean flavor | 4.4 | 3.9 | 3.1 | 2.4 | 1.9 |
| Overall evaluation | 2.6 | 3.0 | 3.3 | 3.0 | 2.6 |

As can be seen from the results shown in Tables 26, 27, 29 and 30, it has been shown that an optimum lower limit and an optimum upper limit of the total content of the soybean powder and the edible fat or oil which can be contained in a cheese-like food comprising the soybean powder and the edible fat or oil is 35 to 50% by mass.

In addition, as can be seen from Comparative Examples 17 and 19, the cheese-like foods having a soybean powder content of 5% by mass lacked the richness originated from soybeans, which presumably contributed to the cheese-like taste, and lacked cheesiness also in terms of feel-on-the-tongue and mouthfeel. In addition, when the edible fat or oil content was 45% by mass, such a cheese-like food gave oiliness when eaten, and the kokumi of soybean was reduced.

As can be seen from Comparative Examples 18 and 23, the cheese-like foods having a soybean powder content of 35% by mass were not smooth in feel-on-the-tongue, and also poor in melt-in-the-mouth. In addition, when the edible fat or oil content was 5% by mass, the softness was insufficient, and the effect of reducing the soybean flavor was present but small.

In addition, as can be seen from the results shown in Tables 29 and 30, it has been found that, regarding the type of edible fat or oil which can be contained in a cheese-like food comprising soybean powder and the edible fat or oil, the triglyceride with medium-chain fatty acids is more suitable than canola oil.

Specifically, regarding Examples 15 to 17, where the triglyceride with medium-chain fatty acids was used as the edible fat or oil, and Comparative Examples 20 to 22, where the canola oil was used as the edible fat or oil, the cheese-like foods of Examples 15 to 17 were acceptable with the scores of all the taste evaluation items being 3.5 or higher, whereas the scores of some of the taste evaluation items were lower than 3.5 in Comparative Examples 20 to 22, and the cheese-like foods of Comparative Examples 20 to 22 were apparently inferior to those of Examples 15 to 17 especially in terms of richness, oily feeling, and soybean flavor, among the evaluation items.

<Evaluation of Cheesiness of Cheese-Like Foods>

In addition, the cheese-like foods produced as described above were evaluated in terms of cheesiness by nine well-experienced panelists. Specifically, the cheese-like foods were eaten and evaluated in terms of cheesiness based on the evaluation criteria in Table 31 (scored to one decimal place). Then, when the average value of the evaluation scores given by the nine panelists was 3.5 or higher, the cheese-like food was determined to have cheesiness. Table 32 shows the cheesiness evaluation results.

TABLE 31
Criteria of cheesiness evaluation

| Evaluation score | Evaluation content |
|---|---|
| 5.0 points | Very good |
| 4.0 points | Good |
| 3.0 points | Intermediate |
| 2.0 points | Poor |
| 1.0 points | Very poor |

TABLE 32
Cheesiness evaluation results

| Comp. | | | | Comp. |
|---|---|---|---|---|
| Ex. 17 | Ex. 15 | Ex. 16 | Ex. 17 | Ex. 18 |
| 2.3 | 3.8 | 4.3 | 4.1 | 2.9 |
| Comp. | Comp. | Comp. | Comp. | Comp. |
| Ex. 19 | Ex. 20 | Ex. 21 | Ex. 22 | Ex. 23 |
| 1.4 | 2.0 | 2.8 | 2.9 | 2.2 |

As can be seen from the results shown in Table 32, it was found that the cheese-like foods obtained in Examples 15 to 17 had cheesiness with scores of the item of the cheesiness evaluation being 3.5 or higher, in contrast to Comparative Examples 17 to 23.

Further, the present invention includes the following modes of gelatinous foods.

[1] A gelatinous food comprising:

4 to 13% by mass of soybean powder; and

3 to 40% by mass of an edible fat or oil containing a triglyceride with a medium-chain fatty acid(s), wherein

the edible fat or oil contains the triglyceride with the medium-chain fatty acid(s) at a ratio of 50% by mass or higher relative to the edible fat or oil.

[2] The gelatinous food according to the above-described [1], further comprising agar and a thickener.
[3] The gelatinous food according to the above-described [1] or [2], wherein

the triglyceride with the medium-chain fatty acid(s) is a triglyceride consisting of the medium-chain fatty acid(s).

[4] The gelatinous food according to any one of the above-described [1] to [3], wherein

the medium-chain fatty acid(s) has(have) 8 to 12 carbon atoms.

[5] The gelatinous food according to any one of the above-described [1] to [4], which does not comprise any allergenic material originated from egg, milk, wheat, buckwheat, peanut, shrimp/prawn/lobster, or crab.
[6] A method for producing a gelatinous food, comprising:

mixing 4 to 13% by mass of soybean powder and 3 to 40% by mass of an edible fat or oil containing a triglyceride with a medium-chain fatty acid(s) with each other, wherein the edible fat or oil contains the triglyceride with the medium-chain fatty acid(s) at a ratio of 50% by mass or higher relative to the edible fat or oil; and then

subjecting the mixture to a heat treatment.

[7] The method for producing a gelatinous food according to the above-described [6], wherein

the triglyceride with the medium-chain fatty acid(s) is a triglyceride consisting of the medium-chain fatty acid(s). [8] The method for producing a gelatinous food according to the above-described [6] or [7], wherein

agar and a thickener are further mixed, and then the heat treatment is performed.

[9] The method for producing a gelatinous food according to any one of the above-described [6] to [8], wherein

the medium-chain fatty acid(s) has(have) 8 to 12 carbon atoms.

[10] The method for producing a gelatinous food according to any one of the above-described [6] to [9], wherein

the gelatinous food does not comprise any allergenic material originated from egg, milk, wheat, buckwheat, peanut, shrimp/prawn/lobster, or crab.

Further, the present invention includes the following modes of liquid foods.

[1] A liquid food comprising:

soybean powder; and

an edible fat or oil, wherein

the edible fat or oil contains a triglyceride with a medium-chain fatty acid(s) at a ratio of 50% by mass or higher relative to the edible fat or oil.

[2] The liquid food according to the above-described [1], wherein

the content of the soybean powder is 3 to 30% by mass, and

the content of the edible fat or oil containing the triglyceride with the medium-chain fatty acid(s) is 5 to 20% by mass, and

the edible fat or oil contains the triglyceride with the medium-chain fatty acid(s) at a ratio of 50% by mass or higher relative to the edible fat or oil.

[3] The liquid food according to the above-described [1] or [2], wherein

the triglyceride with the medium-chain fatty acid(s) is a triglyceride consisting of the medium-chain fatty acid(s).

[4] The liquid food according to any one of the above-described [1] to [3], wherein

the medium-chain fatty acid(s) has(have) 8 to 12 carbon atoms.

[5] A method for producing a liquid food comprising soybean powder and an edible fat or oil, wherein

the edible fat or oil contains a triglyceride with a medium-chain fatty acid(s) at a ratio of 50% by mass or higher relative to the edible fat or oil.

[6] The method for producing a liquid food according to the above-described [5], the method comprising:

mixing 3 to 30% by mass of the soybean powder and 5 to 20% by mass of the edible fat or oil containing the triglyceride with the medium-chain fatty acid(s) with each other, wherein the edible fat or oil contains the triglyceride with the medium-chain fatty acid(s) at a ratio of 50% by mass or higher relative to the edible fat or oil, and then

subjecting the mixture to a heat treatment.

[7] The method for producing a liquid food according to the above-described [5] or [6], wherein

the triglyceride with the medium-chain fatty acid(s) is a triglyceride consisting of the medium-chain fatty acid(s). [8] The method for producing a liquid food according to anyone of the above-described [5] to [7], wherein

the medium-chain fatty acid(s) has(have) 8 to 12 carbon atoms.

Moreover, the present invention includes the following modes of cold sweets.

[1] A cold sweet comprising:

0.2 to 17% by mass of soybean powder; and

0.5 to 28% by mass of an edible fat or oil containing a triglyceride with a medium-chain fatty acid(s), wherein

the content of the triglyceride with the medium-chain fatty acid(s) in the edible fat or oil is 50% by mass or higher.

[2] The cold sweet according to the above-described [1], wherein

the triglyceride with the medium-chain fatty acid(s) is a triglyceride consisting of the medium-chain fatty acid(s) as a constituent fatty acid(s).

[3] The cold sweet according to the above-described [1] or [2], wherein

the medium-chain fatty acid(s) in the triglyceride with the medium-chain fatty acid(s) has (have) 8 to 10 carbon atoms.

[4] The cold sweet according to any one of the above-described [1] to [3], which does not comprise any allergenic material originated from egg, milk, wheat, buckwheat, peanut, shrimp/prawn/lobster, or crab.
[5] The cold sweet according to any one of the above-described [1] to [4], which is an ice cream-like food.
[6] A method for modifying a flavor originated from soybean powder in a food, the method comprising using a triglyceride with a medium-chain fatty acid(s) in combination with the soybean powder.
[7] A method for producing a cold sweet, the method comprising:

preparing a liquid mix containing 0.2 to 17% by mass of soybean powder and 0.5 to 28% by mass of an edible fat or oil containing a triglyceride with a medium-chain fatty acid(s) at a ratio of 50% by mass or higher; then

refrigerating the liquid mix, while air is being introduced into the liquid mix; and then

allowing the liquid mix to freeze.

Moreover, the present invention includes the following modes of soft candies.

[1] A soft candy comprising:

1 to 35% by mass of soybean powder; and

1 to 40% by mass of an edible fat or oil containing a triglyceride with a medium-chain fatty acid(s), wherein the edible fat or oil contains the triglyceride with the medium-chain fatty acid(s) at a ratio of 50% by mass or higher relative to the edible fat or oil.

[2] The soft candy according to the above-described [1], further comprising a thickener.
[3] The soft candy according to the above-described [1] or [2], wherein

the triglyceride with the medium-chain fatty acid(s) is a triglyceride consisting of the medium-chain fatty acid(s).

[4] The soft candy according to any one of the above-described [1] to [3], wherein

the medium-chain fatty acid(s) has(have) 8 to 10 carbon atoms.

[5] The soft candy according to any one of the above-described [1] to [4], which does not comprise any allergenic material originated from egg, milk, wheat, buckwheat, peanut, shrimp/prawn/lobster, or crab.
[6] A method for producing a soft candy, comprising:

mixing 1 to 35% by mass of soybean powder and 1 to 40% by mass of an edible fat or oil containing a triglyceride with a medium-chain fatty acid(s) with each other, wherein the edible fat or oil contains the triglyceride with the medium-chain fatty acid(s) at a ratio of 50% by mass or higher relative to the edible fat or oil; and then

subjecting the mixture to a heat treatment.

[7] The method for producing a soft candy according to the above-described [6], wherein

a thickener is further mixed, and then the heat treatment is performed.

[8] The method for producing a soft candy according to the above-described [6] or [7], wherein

the triglyceride with the medium-chain fatty acid(s) is a triglyceride consisting of the medium-chain fatty acid(s).

[9] The method for producing a soft candy according to any one of the above-described [6] to [8], wherein

the medium-chain fatty acid(s) has(have) 8 to 10 carbon atoms.

[10] The method for producing a soft candy according to any one of the above-described [6] to [9], wherein

the soft candy does not comprise any allergenic material originated from egg, milk, wheat, buckwheat, peanut, shrimp/prawn/lobster, or crab.

Furthermore, the present invention includes the following modes of cheese-like foods.

[1] A cheese-like food comprising:

soybean powder;

an edible fat or oil; and

an organic acid, wherein

the edible fat or oil contains a triglyceride with a medium-chain fatty acid(s) at a ratio of 50% by mass or higher relative to the edible fat or oil.

[2] The cheese-like food according to the above-described [1], wherein

the total content of the soybean powder and the edible fat or oil is 15 to 50% by mass, and

the mass ratio of the soybean powder to the edible fat or oil is 7:1 to 1:7.

[3] The cheese-like food according to the above-described [1] or [2], further comprising a thickener and a flavor.
[4] The cheese-like food according to any one of the above-described [1] to [3], wherein

the triglyceride with the medium-chain fatty acid(s) is a triglyceride consisting of the medium-chain fatty acid(s).

[5] The cheese-like food according to any one of the above-described [1] to [4], wherein

the medium-chain fatty acid(s) has(have) 8 to 12 carbon atoms.

[6] The cheese-like food according to any one of the above-described [1] to [5], which does not comprise any allergenic material originated from egg, milk, wheat, buckwheat, peanut, shrimp/prawn/lobster, or crab.
[7] A method for producing a cheese-like food, the method comprising:

mixing soybean powder, an edible fat or oil, and an organic acid together, wherein the edible fat or oil contains a triglyceride with a medium-chain fatty acid(s) at a ratio of 50% by mass or higher relative to the edible fat or oil; and then

subjecting the mixture to a heat treatment.

[8] The method for producing a cheese-like food according to the above-described [7], wherein

the total content of the soybean powder and the edible fat or oil is 15 to 50% by mass, and

the mass ratio of the soybean powder to the edible fat or oil is 7:1 to 1:7.

[9] The method for producing a cheese-like food according to the above-described [7] or [8], wherein

the triglyceride with the medium-chain fatty acid(s) is a triglyceride consisting of the medium-chain fatty acid(s). [10] The method for producing a cheese-like food according to any one of the above-described [7] to [9], wherein

a thickener and a flavor are further mixed, and then the heat treatment is performed.

[11] The method for producing a cheese-like food according to any one of the above-described [7] to [10], wherein

the medium-chain fatty acid(s) has(have) 8 to 12 carbon atoms.

[12] The method for producing a cheese-like food according to any one of the above-described [7] to [11], wherein the cheese-like food does not comprise any allergenic material originated from egg, milk, wheat, buckwheat, peanut, shrimp/prawn/lobster, or crab.

1. A food comprising:
soybean powder; and
an edible fat or oil, wherein
the edible fat or oil contains a triglyceride with a medium-chain fatty acid(s) at a ratio of 50% by mass or higher relative to the mass of the edible fat or oil.

2. The food according to claim 1, wherein
the triglyceride with the medium-chain fatty acid(s) is a triglyceride consisting of the medium-chain fatty acid(s).

3. The food according to claim 1, wherein
the medium-chain fatty acid(s) has(have) 6 to 12 carbon atoms.

4. The food according to claim 1, which does not comprise at least one of allergenic materials originated from egg, milk, wheat, buckwheat, peanut, shrimp/prawn/lobster, or crab.

5. The food according to claim 1, wherein
the food is a gelatinous food,
the content of the soybean powder is 4 to 13% by mass relative to the total mass of the food, and
the content of the edible fat or oil is 3 to 40% by mass relative to the total mass of the food.

6. The food according to claim 1, wherein
the food is a liquid food,
the content of the soybean powder is 3 to 30% by mass relative to the total mass of the food, and
the content of the edible fat or oil is 5 to 20% by mass relative to the total mass of the food.

7. The food according to claim 1, wherein
the food is a cold sweet,
the content of the soybean powder is 0.2 to 17% by mass relative to the total mass of the food, and
the content of the edible fat or oil is 0.5 to 28% by mass relative to the total mass of the food.

8. The food according to claim 1, wherein
the food is a soft candy,
the content of the soybean powder is 1 to 35% by mass relative to the total mass of the food, and
the content of the edible fat or oil is 1 to 40% by mass relative to the total mass of the food.

9. The food according to claim 1, wherein
the food is a cheese-like food, and further comprises an organic acid,
the total content of the soybean powder and the edible fat or oil is 15 to 50% by mass relative to the total mass of the food, and
the mass ratio of the soybean powder to the edible fat or oil is 7:1 to 1:7.

10. A method for producing a food comprising soybean powder and an edible fat or oil, the method comprising the steps of:
mixing the soybean powder and the edible fat or oil with each other, wherein the edible fat or oil contains a triglyceride with a medium-chain fatty acid(s) at a ratio of 50% by mass or higher relative to the mass of the edible fat or oil; and
subjecting the mixture to a heat treatment.

11. The method for producing a food according to claim 10, wherein
the triglyceride with the medium-chain fatty acid(s) is a triglyceride consisting of the medium-chain fatty acid(s).

12. The method for producing a food according to claim 10, wherein
the medium-chain fatty acid(s) has(have) 6 to 12 carbon atoms.

13. The method for producing a food according to claim 10, wherein
the food does not comprise at least one of allergenic materials originated from egg, milk, wheat, buckwheat, peanut, shrimp/prawn/lobster, or crab.

14. The method for producing a food according to claim 10, wherein
the food is any one selected from the group consisting of a gelatinous food, a liquid food, a cold sweet, a soft candy, and a cheese-like food.

15. A method for improving a flavor originated from soybean powder in a food comprising the soybean powder and an edible fat or oil, the method comprising the steps of:
mixing the soybean powder and the edible fat or oil with each other, wherein the edible fat or oil contains a triglyceride with a medium-chain fatty acid(s) at a ratio of 50% by mass or higher relative to the mass of the edible fat or oil; and
subjecting the mixture to a heat treatment.
